(19) United States
(12) Patent Application Publication
(10) Pub. No.: US 2026/0080411 A1
(43) Pub. Date: Mar. 19, 2026

(54) MULTI-STAGE UNSUPERVISED LEARNING FOR EXTREME LOW-FRAUD SCENARIOS

(71) Applicant: ACTIMIZE LTD, Ra'anana (IL)

(72) Inventors: Yonit MARCUS, Rehovot (IL); Michal EINHORN-COHEN, Rosh Haayin (IL); Danny BUTVINIK, Haifa (IL)

(21) Appl. No.: 18/888,931

(22) Filed: Sep. 18, 2024

(51) Int. Cl. G06Q 20/40

(52) U.S. Cl. CPC G06Q 20/4016

(57) ABSTRACT

A system is adapted to automatically identify suspected fraudulent transactions. The system includes a fraud management server configured to perform these operations: receiving unlabeled transactions, each having a number of features, and storing them in a transaction repository; with the features, determining a risk score for each transaction; based on the risk scores, dividing the unlabeled transactions into bins in order of their risk scores; labeling transactions of the first bin legitimate and those of last bin as fraudulent; with the labeled transactions, training a first machine learning model; with the trained first machine learning model, labeling transactions of a second bin and a second-to-last bin as either fraudulent or legitimate; storing the labeled transactions of the first bin, second bin, second-to-last bin, and last-bin in the transaction repository; and with the labeled transactions of the first bin, second bin, second-to-last bin, and last-bin, training a second machine learning model.

### COPYRIGHT NOTICE

A portion of the disclosure of this patent document contains material which is subject to copyright protection. The copyright owner has no objection to the facsimile reproduction by anyone of the patent document or the patent disclosure, as it appears in the U.S. Patent and Trademark Office patent file or records, but otherwise reserves all copyright rights whatsoever.

### TECHNICAL FIELD

The subject matter described herein relates to systems, methods, and devices for automatically detecting fraud in low-fraud environments. This multi-stage machine-learning fraud detection system has particular but not exclusive utility for identifying and blocking fraudulent banking transactions.

### BACKGROUND

Machine Learning (ML) is a subset of artificial intelligence (AI) that focuses on the use of data and algorithms to imitate the way that humans learn, gradually improving its accuracy. ML utilizes statistical techniques to give computer systems the ability to “learn” (i.e., progressively improve performance on a specific task) with data, without being explicitly programmed. In fraud detection, ML algorithms can analyze millions of transactions to identify hidden patterns and anomalies that may indicate fraud. One aspect of ML's role is its ability to adapt to new, previously unseen patterns of fraud, which are typical in sophisticated financial crime scenarios. Additionally, machine learning facilitates the deployment of models that can continuously learn and evolve as they are exposed to new transaction data, thus maintaining high accuracy over time, despite changes in fraudulent tactics. This adaptability is crucial for keeping up with the dynamic nature of financial fraud.

However, there are numerous challenges associated with detecting fraudulent transactions in environments characterized by extremely low incidences of fraud. For example, in some commercial segments where fraud is more sophisticated and targeted, the number of transactions that are fraudulent may be as low as 0-5 cases per month, out of a total of several million transactions. These environments typically struggle with inadequate labeled data, which hampers the training and effectiveness of traditional machine learning models.

The domain of fraud detection within financial technology has experienced transformative advancements yet continues to face formidable challenges in scenarios characterized by extremely low incidences of fraud. These low-fraud environments are particularly prevalent in sectors like commercial banking, where transactions are not only voluminous, but where fraudulent transactions also exhibit a high degree of sophistication and are specifically targeted to exploit systemic vulnerabilities. Traditional fraud detection methodologies falter in these settings primarily due to the scarcity of labeled data. Labeled instances of fraud, which are essential for the training and effective operation of machine learning models, are typically minimal, thereby undermining the models' ability to detect new and evolving fraudulent tactics. This gap significantly heightens the risk of financial losses, necessitating an innovative approach that can enhance detection capabilities while addressing the intrinsic limitations of data scarcity. Thus, systems and methods to detect fraudulent transactions in environments having extremely low fraud rates are desired.

The information included in this Background section of the specification, including any references cited herein and any description or discussion thereof, is included for technical reference purposes only and is not to be regarded as subject matter by which the scope of the disclosure is to be bound.

### SUMMARY

Disclosed is a multi-stage machine-learning fraud detection system. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a system adapted to automatically identify suspected fraudulent transactions. The system includes a fraud management server having at least one processor and a non-transitory computer readable medium operably coupled thereto, the server being in electronic communication with a computing device of a financial institution, the processor including a transaction repository, an anomaly detection model, and a transaction classification model, the server being in electronic communication with a database for storing a plurality of features for a plurality of transactions associated with the financial institution, the computer readable medium including a plurality of instructions stored in association therewith that are accessible to, and executable by, the processor, to perform operations. The operations may include: receiving a plurality of unlabeled transactions, each transaction having a respective plurality of features; storing the unlabeled transactions in the transaction repository; with the anomaly detection model and the respective pluralities of features for the plurality of unlabeled transactions, determining a respective plurality of transaction risk scores, where each transaction risk score is a value between 0 and 1, where higher values represent a greater risk that the transaction is fraudulent; based on the plurality of transaction risk scores, dividing the unlabeled transactions into a plurality of bins, where a first bin of the plurality of bins contains transactions with the lowest respective risk scores, and where a last bin of the plurality of bins contains transactions with the highest respective risk scores; labeling transactions of the first bin of the plurality of bins as legitimate; labeling transactions of the last bin of the plurality of bins as fraudulent; with the transaction classification model and the labeled transactions of the first and last bins and their respective pluralities of respective features, training a first machine learning model; with the trained first machine learning model and the respective pluralities of features, labeling transactions of a second bin of the plurality of bins and a second-to-last bin of the plurality of bins as either fraudulent or legitimate; and storing the labeled transactions of the first bin, second bin, second-to-last bin, and last-bin in the transaction repository. Other embodiments of this aspect include corresponding computer systems, apparatus, and computer programs recorded on one or more computer storage devices, each configured to perform the actions of the methods.

Implementations may include one or more of the following features. In some embodiments, the operations further may include: with the transaction classification model and the labeled transactions of the first bin, second bin, second-to-last bin, and last-bin and their respective pluralities of respective features, training a second machine learning model; with the trained second machine learning model, labeling transactions of a third bin and a third-to-last bin of the plurality of bins as either fraudulent or legitimate; and storing the labeled transactions of the third bin and the third-to-last bin in the transaction repository. In some embodiments, the operations further may include: with the transaction classification model and the labeled transactions of the first bin, second bin, nth bin, nth-to-last bin, second-to-last bin, and last-bin and their respective pluralities of respective features, training an nth machine learning model. In some embodiments, the operations further may include: receiving a second plurality of transactions; and with the trained nth machine learning model, classifying transactions of the second plurality of transactions as either fraudulent or legitimate. In some embodiments, the operations further may include: blocking the transactions of the second plurality of transactions that are classified as fraudulent. In some embodiments, the operations further may include: for each transaction of the second plurality of transactions that is classified as fraudulent, generating an alert message to a user. In some embodiments, the operations further may include: for each transaction of the second plurality of transactions that is classified as fraudulent, passing the transaction to a fraud investigator processor via a network. In some embodiments, the first machine learning model or the second machine learning model may include an adaptive entropy gradient model. In some embodiments, the bins of the plurality of bins are of equal risk score width. In some embodiments, determining the respective plurality of transaction risk scores may include: segmenting the plurality of unlabeled transactions into segments; and running the anomaly detection model on each segment separately. Implementations of the described techniques may include hardware, a method or process, or computer software on a computer-accessible medium.

One general aspect includes a computer-implemented method for automatically identifying suspected fraudulent transactions. The computer-implemented method includes, with a fraud management server having at least one processor and a non-transitory computer readable medium operably coupled thereto, the server being in electronic communication with a computing device of a financial institution, the processor including a transaction repository, an anomaly detection model, and a transaction classification model, the server being in electronic communication with a database for storing a plurality of features for a plurality of transactions associated with the financial institution: receiving a plurality of unlabeled transactions, each transaction having a respective plurality of features; storing the unlabeled transactions in the transaction repository; with the anomaly detection model and the respective pluralities of features for the plurality of unlabeled transactions, determining a respective plurality of transaction risk scores, where each transaction risk score is a value between 0 and 1, where higher values represent a greater risk that the transaction is fraudulent; based on the plurality of transaction risk scores, dividing the unlabeled transactions into a plurality of bins, where a first bin of the plurality of bins contains transactions with the lowest respective risk scores, and where a last bin of the plurality of bins contains transactions with the highest respective risk scores; labeling transactions of the first bin of the plurality of bins as legitimate; labeling transactions of the last bin of the plurality of bins as fraudulent; with the transaction classification model and the labeled transactions of the first and last bins and their respective pluralities of respective features, training a first machine learning model; with the trained first machine learning model and the respective pluralities of features, labeling transactions of a second bin of the plurality of bins and a second-to-last bin of the plurality of bins as either fraudulent or legitimate; and storing the labeled transactions of the first bin, second bin, second-to-last bin, and last-bin in the transaction repository. Other embodiments of this aspect include corresponding computer systems, apparatus, and computer programs recorded on one or more computer storage devices, each configured to perform the actions of the methods.

Implementations may include one or more of the following features. In some embodiments, the method may include: with the transaction classification model and the labeled transactions of the first bin, second bin, second-to-last bin, and last-bin and their respective pluralities of respective features, training a second machine learning model; with the trained second machine learning model, labeling transactions of a third bin and a third-to-last bin of the plurality of bins as either fraudulent or legitimate; and storing the labeled transactions of the third bin and the third-to-last bin in the transaction repository. In some embodiments, the method may include: with the transaction classification model and the labeled transactions of the first bin, second bin, nth bin, nth-to-last bin, second-to-last bin, and last-bin and their respective pluralities of respective features, training an nth machine learning model. In some embodiments, the method may include: receiving a second plurality of transactions; and with the trained nth machine learning model, classifying transactions of the second plurality of transactions as either fraudulent or legitimate. In some embodiments, the method may include: blocking the transactions of the second plurality of transactions that are classified as fraudulent. In some embodiments, the method may include: for each transaction of the second plurality of transactions that is classified as fraudulent, generating an alert message to a user. In some embodiments, the method may include: for each transaction of the second plurality of transactions that is classified as fraudulent, passing the transaction to a fraud investigator processor via a network. In some embodiments, the first machine learning model or the second machine learning model may include an adaptive entropy gradient model. In some embodiments, the bins of the plurality of bins are of equal risk score width. In some embodiments, determining the respective plurality of transaction risk scores may include: segmenting the plurality of unlabeled transactions into segments; and running the anomaly detection model on each segment separately. Implementations of the described techniques may include hardware, a method or process, or computer software on a computer-accessible medium.

The multi-stage machine-learning fraud detection system disclosed herein has particular, but not exclusive, utility for detecting fraud in banking transactions.

This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages of the multi-stage machine-learning fraud detection system, as defined in the claims, is provided in the following written description of various embodiments of the disclosure and illustrated in the accompanying drawings.

### BRIEF DESCRIPTION OF THE DRAWINGS

Illustrative embodiments of the present disclosure will be described with reference to the accompanying drawings, of which:

FIG. 1 is a schematic, diagrammatic representation, in block diagram form, of an example multi-stage machine-learning fraud detection system 100, in accordance with at least one embodiment of the present disclosure.

FIG. 2 is a schematic, diagrammatic representation, in block diagram form, of an example computing system architecture 200, in accordance with at least one embodiment of the present disclosure.

FIG. 3 is a schematic diagram of a processor circuit 350, according to embodiments of the present disclosure.

FIG. 4 is a graphical representation of a group of transactions 240, in accordance with at least one embodiment of the present disclosure.

FIG. 5 is a schematic, diagrammatic representation, in block diagram form, of an example multi-stage machine-learning fraud detection system 500, in accordance with at least one embodiment of the present disclosure.

FIG. 6A is a graphical representation 600 of ground-truth legitimate transactions 640 and fraudulent transactions 650, in accordance with at least one embodiment of the present disclosure.

FIG. 6B is a graphical representation 660 of machine-learning-classified legitimate transactions 640 and fraudulent transactions 650, in accordance with at least one embodiment of the present disclosure.

FIG. 7 is a graphical representation of 33 variables or features 510 with respect to a decision boundary 740 for a particular exemplary fraudulent transaction, in accordance with at least one embodiment of the present disclosure.

FIG. 8 is a schematic, diagrammatic representation of a software systems architecture 800, in accordance with at least one embodiment of the present disclosure.

FIG. 9 is a schematic, diagrammatic representation, in flow diagram form, of an example fraud detection method 900, in accordance with at least one embodiment of the present disclosure.

FIG. 10 is a schematic, diagrammatic representation, in flow diagram form, of an example multi-stage machine-learning fraud detection method, in accordance with at least one embodiment of the present disclosure.

### DETAILED DESCRIPTION

In accordance with at least one embodiment of the present disclosure, a multi-stage machine-learning fraud detection system is provided which, in multiple stages, turns unlabeled data into labeled data that can be used to train successively more accurate machine learning models, until a final model is created that can be used for inference in detecting and otherwise investigating fraud, even for extremely low incidence environments.

By leveraging a hybrid of supervised and unsupervised learning methods, the present disclosure provides a novel approach to model training and fraud prediction, even in the absence of sufficient labeled data. This hybrid approach harnesses the strengths of both learning paradigms: unsupervised learning to identify unusual patterns and outliers in transaction data, which may indicate potential fraud, and supervised learning to refine these detections by classifying transactions based on artificially generated labels that simulate real-world fraud scenarios. The synergy between these methods enhances the model's ability to adapt and respond to emerging fraudulent tactics without the need for extensive historical fraud labels, thereby significantly reducing the reliance on manual data labeling and expert intervention. This makes the multi-stage machine-learning fraud detection system particularly suitable for sectors where fraud patterns evolve rapidly, and historical data may not fully capture the spectrum of potentially fraudulent activities.

The present disclosure is deeply rooted in several interrelated technological domains that are critical for modern financial crime detection systems:

### 1. Machine Learning (See Above)

### 2. Clustering Analysis—

A technique in machine learning that involves grouping a set of objects in such a way that objects in the same group (called a cluster) are more similar to each other than to those in other groups. In the context of fraud detection, clustering is useful for several reasons:

Segmentation of Data: Clustering divides transaction data into homogeneous groups based on their characteristics. This segmentation helps in identifying distinct patterns or behaviors within each group, which can be crucial for accurate anomaly detection.

Handling Data Variability: Different clusters may represent different types of transaction behaviors, such as high-value transactions in one cluster and low-value transactions in another. Each cluster may require a different approach to detect anomalies effectively.

Enhanced Detection Sensitivity: By focusing on smaller, more similar groups of data, clustering enhances the sensitivity of the anomaly detection algorithms. Anomalies that might be diluted in a larger dataset can be more easily detected within smaller, homogeneous groups.

Adaptation to New Patterns: Clustering can dynamically adapt to new data, helping financial institutions stay ahead of emerging fraudulent tactics without needing constant reconfiguration of the detection system.

### 3. Unsupervised Anomaly Detection—

An important component of the present disclosure, especially in scenarios where labeled data is not available. This technique uses machine learning algorithms to identify unusual patterns or outliers in the data that could indicate potential fraud:

Algorithm Selection: Various algorithms can be used for unsupervised anomaly detection, including Isolation Forest, One-Class SVM, and Local Outlier Factor (LOF). These algorithms are capable of identifying data points that deviate significantly from the norm established by the dataset or cluster.

Operational Mechanism: These algorithms typically work by constructing a model of what normal transactions look like and then scoring each new transaction based on how well it fits this model. Transactions that do not fit well (i.e., have a high anomaly score) are flagged as potential fraud.

Application to Clusters: By applying these algorithms within the clustered data, the system can more accurately identify anomalies that are specific to the transaction patterns of each cluster, rather than using a one-size-fits-all approach across all transactions.

Feedback and Improvement: The unsupervised models also benefit from continuous feedback and recalibration. As new transactions are processed and more data becomes available, the models can be refined and adjusted to improve their accuracy and reduce false positives.

### 4. Supervised Learning

Supervised learning is an important feature of the present disclosure, specifically utilized in the later stages of the fraud detection process. It involves training a model on a labeled dataset where the outcomes are known, which in the case of the present disclosure includes both artificially generated labels from the unsupervised phase and any available real fraud labels. The primary algorithm used here is logistic regression, a powerful statistical method that predicts a binary outcome (fraud or no fraud) based on input variables derived from transaction data.

Logistic regression is particularly suited for this task due to its ability to provide probabilities that a given transaction is fraudulent, facilitating the setting of thresholds for decision-making on whether a transaction should be flagged as suspicious. It also has the advantages of being relatively simple to implement and interpret, making it easier for financial institutions to adopt and integrate into their existing systems.

The supervised learning component of the present disclosure may be important for refining the fraud detection capabilities of the system. By training on a combination of artificial and real labels, the model learns to recognize patterns that are indicative of fraud more accurately. This dual-input training approach helps mitigate the limitations of having sparse labeled data in environments with low fraud incidence, enhancing the model's ability to generalize from limited examples of fraud.

### 5. Financial Crime (FinCrime) Fraud Detection—

The strategies and technologies used to identify and prevent fraudulent activities within financial systems. These activities can range from simple frauds, such as unauthorized credit card transactions, to more sophisticated schemes, such as identity theft and complex money laundering operations. The challenge in FinCrime fraud detection is immense due to the clever and continually evolving tactics employed by fraudsters.

The present disclosure specifically addresses fraud detection in scenarios characterized by extremely low fraud rates, which are typical in certain commercial segments where transactions are large and fraud attempts are highly sophisticated. Traditional methods often fall short in these environments due to the lack of sufficient fraudulent cases to train effective detection models.

By employing a hybrid approach of unsupervised and supervised learning, the present disclosure enhances the ability of financial institutions to detect fraud proactively. This approach allows for the initial identification of potentially fraudulent transactions through anomaly detection without prior labels. It then refines this detection by applying unsupervised learning to create labels, which are then used in a supervised learning step to develop a predictive model that is continuously improved as it is exposed to more transaction data.

The practical implementation of the present disclosure in FinCrime fraud detection enables institutions not only to detect known types of fraud but also to adapt to novel fraudulent behaviors that have not been previously encountered or even recognized. This adaptive capability may be important for maintaining the integrity of financial systems and protecting them against both current and emerging fraud threats. Moreover, the approach supports compliance with regulatory requirements for fraud prevention, which are becoming increasingly stringent as the financial landscape evolves and which differ between legal jurisdictions.

Overall, the integration of the present disclosure into financial crime detection workflows represents a significant advancement in the field, offering robust, scalable, and adaptable solutions that can keep pace with the dynamic nature of financial fraud.

The present disclosure finds its application primarily in the financial services industry, where it can be used by banks, credit card companies, and other financial institutions to significantly enhance their fraud detection capabilities. By reducing the reliance on manually labeled data and the intensive involvement of subject matter experts, the present disclosure enables these entities to efficiently identify potentially fraudulent transactions in real-time. This advancement not only minimizes financial losses due to fraud but also optimizes operational efficiency, allowing for quicker and more accurate decision-making processes.

The present disclosure introduces a groundbreaking approach by integrating supervised and unsupervised learning techniques to form a robust hybrid model capable of operating effectively even in the absence of substantial labeled data. The resultant model is additionally expected to efficiently increase the speed and rate of FinCrime detection. One aspect of this model is its ability to harness the strengths of both types of learning paradigms, enhancing the detection and prevention capabilities for fraud in financial transactions. In the initial phase, the unsupervised component employs advanced anomaly detection algorithms to sift through transactional data, identifying unusual patterns and outliers that may signal potential fraud. This method is invaluable in environments where labeled data is scarce or completely absent, providing a preliminary filter that highlights transactions worthy of further scrutiny. Following this, the supervised component of the model takes over, utilizing artificially generated labels from the unsupervised phase, along with any real, albeit limited, labeled data available. This phase involves training a logistic regression model that meticulously classifies each transaction, assessing the likelihood of fraudulent activity with enhanced precision. This strategic integration of unsupervised and supervised learning not only broadens the model's applicative scope but also amplifies its predictive accuracy, establishing a formidable barrier against fraudulent transactions.

On the other hand, the supervised learning component capitalizes on the groundwork laid by the unsupervised phase. It uses the outputs—identified as potential anomalies—along with any available real-world labeled data to train a logistic regression model. This model may be meticulously designed to classify transactions with a high degree of accuracy, effectively determining the probability of each transaction being fraudulent. By using logistic regression, the model provides a quantifiable measure of risk for each transaction, offering a range from very unlikely to highly likely to be fraudulent. This probabilistic assessment is crucial for financial institutions as it helps in setting precise thresholds for decision-making, such as determining which transactions to flag for manual review or to block outright.

Furthermore, the synergy between the unsupervised and supervised learning components allows for the dynamic adaptation of the detection system to new and unforeseen fraud patterns, which represents a significant enhancement over traditional static models.

By significantly reducing the dependency on manual labeling and expert intervention, the model disclosed herein not only slashes the time and resources typically required for the labor-intensive tasks of data labeling and model training, but also dramatically enhances the scalability and responsiveness of fraud detection systems to emerging threats. This shift facilitates a more agile response in high-stakes environments, where the cost and impact of fraud can be severe. Financial institutions, particularly those involved in commercial banking where the transaction volumes are immense and the sophistication of fraud attempts is continually evolving, stand to benefit immensely from the implementation of this model. The ability of the model to autonomously learn from transactional data in real time and to adapt to novel fraud signatures as they emerge empowers these institutions to proactively manage and mitigate fraud risks by detecting previously undetectable FinCrimes and detecting FinCrimes faster. Additionally, the model's adaptability ensures that it remains effective over time, adjusting to new patterns of fraudulent activity without the need for constant human oversight, thus providing a sustainable and robust solution to the challenges of modern financial fraud detection.

The present disclosure aligns with current regulatory demands for rigorous fraud detection mechanisms in financial operations, enhancing compliance and securing customer trust. By automating the detection process and improving the accuracy of fraud identification, financial institutions can protect their operations from potential fraud-related losses more effectively, ensuring the safety and integrity of the financial ecosystem.

The introduction of this hybrid supervised/unsupervised learning model marks a significant advancement in the field of financial technology. It addresses critical gaps in existing fraud detection methodologies, offering a scalable, efficient, and highly effective solution to one of the most pressing challenges in the financial services industry. The present disclosure elaborates on the technical details, operational efficiencies, and practical applications of this innovative approach, setting a new standard in the fight against financial fraud.

The systems and methods disclosed herein may help address the fundamental challenges faced in the domain of fraud detection within the financial technology sector, particularly under conditions of low fraud incidence typical of commercial segments. These challenges include extreme fraud imbalance with insufficient training samples, a strong bias toward the majority class leading to false negatives, reliance on unsupervised anomaly detection with its inherent high false positives, and difficulty in detecting sophisticated fraud, obscured fraudulent patterns due to the evolving nature of fraud tactics, limited data sharing across financial institutions, and the heavy dependence on domain expertise for manual tuning and interpretation. Each of these issues contributes to the inefficacy of current fraud detection systems and underscores the urgent need for a novel approach that can adapt swiftly to new and evolving fraudulent tactics without extensive manual intervention

The present disclosure pertains to the domain of fraud detection within the financial technology sector, where detecting fraudulent transactions is particularly challenging due to the low incidence of fraud. This scenario is common in commercial segments where the volume of transactions is enormous, but the actual occurrences of fraud are minimal and often sophisticated, targeting specific vulnerabilities within systems or processes.

### Extreme Fraud Imbalance

Extreme fraud imbalance occurs when the instances of fraud in a dataset are significantly fewer than non-fraudulent instances. This condition is prevalent in sectors where large volumes of transactions occur and fraudulent activities are rare. The rarity of fraud cases introduces several challenges:

Insufficient Training Samples for Fraud: Supervised learning models, which are sometimes used in fraud detection, require a balanced dataset of fraudulent and legitimate transactions to learn effectively. In cases of extreme fraud imbalance, there tend not to be enough fraudulent samples to adequately train these models, leading to poor generalization capabilities.

Model Bias towards Majority Class: In extremely imbalanced datasets, there is a strong bias towards the majority class (non-fraudulent transactions). This can result in a high number of false negatives, where fraudulent transactions are not identified.

Evaluation Metrics Inefficacy: Traditional metrics such as accuracy become less meaningful in imbalanced datasets because a model can achieve high accuracy by simply predicting the majority class. More nuanced metrics are needed to evaluate model performance accurately.

### Reliance on Unsupervised Anomaly Detection

Due to the limitations of supervised models in conditions of extreme fraud imbalance, many fraud detection systems use unsupervised anomaly detection. This method does not require labeled data and instead identifies outliers based on deviations from normal patterns in the data. While beneficial in certain aspects, this approach has its own set of challenges:

High False Positives: Anomaly detection models can often flag unusual but legitimate transactions as fraudulent due to their deviation from typical patterns. This can be especially problematic in diverse transaction environments where non-fraudulent transactions may not follow a uniform pattern.

Difficulty in Detecting Sophisticated Fraud: Fraudsters often devise sophisticated methods that mimic legitimate transaction patterns. Unsupervised anomaly detection might fail to identify these as anomalies, especially if the fraudulent transactions are carefully designed to fit within the ‘normal’ parameters defined by the model.

Lack of Historical Context: Unsupervised models generally assess transactions in isolation, lacking the context that might indicate whether a transaction is part of a broader fraudulent scheme. This limitation can reduce their effectiveness in identifying complex fraud schemes that require contextual interpretation.

### Rarity of Fraud

Fraud, especially in commercial segments, may be inherently rare relative to the volume of legitimate transactions. This rarity means that even highly accurate models might struggle to detect fraud due to the scarcity of examples to learn from. The lack of exposure to diverse fraudulent scenarios during the training phase of a model can severely impair its ability to generalize and detect new types of fraud effectively.

### Obscured Fraudulent Patterns

Fraudulent patterns are often obscured for several reasons:

Tactics Evolution: Fraudsters continually adapt and evolve their strategies to avoid detection. This makes fraud detection a moving target, where the patterns that indicate fraudulent activity change over time.

Sophistication and Disguise: Many fraud schemes are sophisticated and designed to mimic legitimate transaction patterns. This makes it difficult for both unsupervised and supervised learning models to distinguish between fraudulent and non-fraudulent activities without a significant number of indicative features that can signal discrepancies.

### Limited Data Sharing

Financial institutions often operate in silos when it comes to sharing data about fraud due to privacy concerns, competitive interests, and the potential reputational damage of being seen as vulnerable to fraud. This lack of data sharing exacerbates the problem of data scarcity and limits the effectiveness of machine learning models, which perform better with more comprehensive datasets. The siloed nature of fraud data across institutions means that:

Collective Learning is Hindered: The potential insights from cross-institutional data, which could significantly enhance the detection of emerging fraud patterns, are not realized.

Inconsistent Data Standards: There is no unified approach to handling and categorizing fraud, leading to inconsistencies in how fraud is reported and analyzed, which further complicates the training of effective detection systems.

### Delayed Performance Feedback in Fraud Detection

Another significant challenge in the fraud detection domain is the ‘curse of delayed performance feedback.’ In many scenarios, immediate feedback on the prediction score of transactions is not available, and it takes a considerable amount of time to obtain ground-truth data for those transactions. During this interval, systems are compelled to operate predominantly in an unsupervised mode, and the accumulation of labeled data necessary for refining models proceeds at a sluggish pace. This delay hampers the ability of fraud detection systems to adapt swiftly and accurately to emerging fraud trends, thereby increasing the risk of both false positives and false negatives.

### Human Error and Oversight in Fraud Detection Investigations

A substantial challenge in fraud detection arises from potential human error and oversight during the investigation process. For instance, even when a transaction (e.g., trx A) is correctly identified by a system as fraudulent and assigned a high-risk score, it may not always be recognized as such by bank investigators. The rigorousness of their review does not eliminate the possibility of oversight or error. Additionally, the subjective nature of fraud verification can lead to discrepancies; for example, a transaction may initially be dismissed as legitimate based on customer confirmation. These instances highlight the critical need for enhancing the reliability of fraud detection systems to mitigate human error and ensure the accurate identification of fraudulent activities

### Implications for Fraud Detection Systems

These challenges necessitate innovative approaches to fraud detection that can operate effectively even with these inherent limitations. The hybrid model of supervised and unsupervised learning, as proposed, aims to address these issues by creating a system that can generate its own training signals (artificial labels) from the data itself, thereby reducing dependence on limited and often outdated labeled data. Furthermore, enhancing collaborative models through anonymized data sharing frameworks or synthetic data generation could help overcome the obstacles posed by data silos.

### Dependence on Domain Expertise

Current systems heavily rely on continuous input and tuning from domain experts (Subject Matter Experts, SMEs) to adjust model parameters and interpret ambiguous cases. This dependence not only introduces a scalability issue but also increases the operational cost and introduces a delay in response times to emerging threats.

### Regulatory and Compliance Challenges

Financial institutions face stringent regulatory requirements aimed at preventing fraud, and failure to comply can result in severe penalties, legal challenges, and significant reputational damage. The rapidly evolving nature of financial regulations necessitates fraud detection systems that are not only highly effective but also adaptable and quick to configure. Current models often fall short in this regard, as they struggle to keep pace with new regulatory demands and the sophisticated tactics employed by fraudsters. This section emphasizes the critical need for the proposed hybrid supervised/unsupervised learning model, which offers the flexibility and responsiveness necessary to meet these regulatory challenges head-on, thereby safeguarding institutions against compliance risks and enhancing their ability to protect their operations from fraudulent activities.

The challenges highlighted underscore the critical need for an innovative approach to fraud detection, particularly in environments where fraud rates are exceedingly low, yet the sophistication and variability of fraud are high. The disclosed hybrid supervised/unsupervised learning model is designed to effectively navigate these complexities. By enhancing model training through the creation of artificial training signals and reducing reliance on domain experts, this model improves both the speed and accuracy of fraud detection mechanisms. Additionally, it offers the adaptability required to swiftly respond to new regulatory requirements and evolving fraudulent tactics. This approach is poised to set new benchmarks in operational efficiency and effectiveness, revolutionizing fraud detection capabilities within the financial services industry.

### Entropy-Reduced Autogenic Learning Algorithm

### Initial Model Training:

The system begins by training a model on the seed labeled data-based entropy-reduction. The seed labeled data in an example case are labels that were derived from initial process of unsupervised contextual anomaly detection algorithm (contextual, means anomaly detection was performed in a specific context), like transactions that were grouped by a particular logic. This initial model serves as the base predictor. The present disclosure defines these labels as seed labels.

### Prediction on Unlabeled Data

The trained model on seeds labels is then used to make predictions on the unlabeled data.

### Confidence Thresholding

Among these predictions, the present disclosure selects the instances (transactions) where the model predicts with high confidence. The confidence threshold may be very important, in that it ensures that only the predictions the model is most sure about are used in the next steps.

### Self-Generated Labeling

The confidently predicted unlabeled instances are assigned labels based on the model's predictions. These new labels are called self-generated labels because they are generated by the model, not by human annotators.

### Model Re-Training

The model is re-trained on a new dataset that combines the seed labeled data with the self-generated labeled data. This expanded training set can help the model learn better and generalize more effectively.

### Iteration

The labeling and training steps are often repeated in multiple iterations, with the model potentially improving each time as it receives more labeled data (both real and pseudo) to learn from.

Calculated scores per each transaction per each cluster go to an entropy-based binning system for transactions score calculation, where all transactions fall into their corresponding bin. The idea of entropy-based binning reflects the notion of entropy, informativeness, and classification confidence, which are believed (without being bound by theory) to provide one or more of the advantages described in this disclosure. Scored transactions that fall into peripheral bins have low entropy, high classification confidence, but tend to have low informativeness for training the model. That is due to the concept of high uncertainty in the scored transactions that fall into the middle bins that are closer to the decision border of the machine learning model. In this predictive confidence scale, 0.5 represents a theoretical boundary decision near which each scored transaction has high informativeness for training the model, but also high uncertainty (entropy) and low classification confidence.

Every time a trained model is given unlabeled data, the model labels it, and then is trained on the labels that it previously labeled together with the remaining labeled transactions. That way, each training iteration, the model (in an example case this is Logistic Regression-legit) is given transactions that are closer and closer to the boundary decision. The rationale behind this order is to expose the model gradually to the hardest-to-predict transactions by training it on the data that has less uncertainty (entropy), until the model becomes smarter and smarter to more accurately make difficult decisions for transactions that near the boundary decision.

Finally, all transactions in evenly divided bins (e.g., bins of equal width) are labeled by an autogenic self-learning process. The last step according to this disclosure is generally to train the final model based on all-labeled transactions together, although additional steps can be included based on the guidance herein.

The final trained model is used to predict new data (e.g., in a live inference mode operating in real time or near-real time). If a scored transaction gets a high score it may be blocked by the machine learning system and sent to an investigation process. After final verification of the fraud, the system updates the database or repository of all transactions so the system can finally perform precise evaluation of the model comparing predicted labels vs. actual labels, which can help inform future labeling processes and increase the accuracy of the model when used on newly collected transaction data.

The present disclosure addresses the challenge of extreme fraud imbalance through a hybrid approach combining unsupervised and supervised methodologies, effectively mitigating the limitations posed by the scarcity of fraudulent samples. Firstly, the system clusters transactions based on expert-defined rules and features, grouping them into segments where similarities are shared. Within these clusters different Anomaly Detection algorithms are employed to assess each transaction's anomaly score relative to its cluster. This unsupervised step allows the system to identify potentially fraudulent transactions without needing a balanced dataset, thus circumventing or at least minimizing the issue of insufficient training samples.

By pseudo-labeling transactions based on predefined thresholds, the method prepares a dataset that, although initially derived from an unsupervised model, includes both “fraudulent” and “legitimate” transactions. This dataset is then used to train a supervised Logistic Regression model, which enhances its ability to generalize from previously underrepresented fraudulent cases.

Lastly, the approach helps overcome the challenge posed by traditional evaluation metrics. The initial unsupervised step of scoring and pseudo-labeling provides a more nuanced way to identify and label potential fraud, allowing the supervised model to focus on refining these identifications rather than merely predicting the overwhelming majority class. This facilitates the use of more sophisticated metrics that can evaluate the model's ability to detect fraud accurately, rather than just its accuracy in predicting the majority class. Thus, the present disclosure enhances the effectiveness of fraud detection systems in scenarios characterized by extreme fraud imbalance.

The present disclosure directly addresses the challenges associated with reliance on unsupervised anomaly detection in several compelling ways. Firstly, by clustering transactions based on domain-specific logic and features selected by subject matter experts (SMEs), the system introduces a layer of contextual understanding that goes beyond simple anomaly detection. This reduces the rate of false positives, as transactions are assessed within clusters that reflect more homogeneous patterns, making it easier to distinguish between genuine anomalies and mere deviations from typical but still legitimate behaviors.

Moreover, the incorporation of pseudo-labeling based on thresholds defined by SMEs bridges the gap between unsupervised and supervised methods. It allows the system to utilize a logistic regression model trained on both legitimate and pseudo-labeled fraudulent transactions, enhancing the model's capability to recognize sophisticated fraud patterns. These patterns might otherwise be missed by standard unsupervised methods, because the pseudo-labeling injects an element of supervised learning, informed by expert insights into what constitutes suspicious activity, thereby improving detection accuracy.

Initially, the algorithm clusters transactions based on features selected by subject matter experts (SMEs), a step that organizes data into groups where transactions share similar characteristics. This clustering may be highly important because it allows the unsupervised anomaly detection algorithm to be applied within these contextually similar groups. By evaluating transactions within these clusters, the anomaly detection (AD) algorithm can more accurately identify outliers or potentially fraudulent activities, even in the absence of a large number of known fraudulent examples.

Once outliers are identified, they are pseudo-labeled as potentially fraudulent. This pseudo-labeling serves as a preparatory step that generates a preliminary set of labeled data, which includes both ‘legitimate’ and ‘fraudulent’ transactions, despite the actual scarcity of true fraud examples. This dataset then serves as the training set for a supervised Logistic Regression model.

The supervised Logistic Regression model trained on this pseudo-labeled data is better equipped to generalize and identify fraud in new transactions. This is because the model training integrates insights derived from the unsupervised phase, which is sensitive to subtle anomalies and irregular patterns that may indicate fraud. Thus, even with the inherent rarity of fraud, the model can learn from a broader range of fraudulent-like scenarios provided by the unsupervised learning phase. Additionally, such supervised Logistic Regression models may also more efficiently and quickly identify new types of fraud.

Overall, this hybrid model compensates for the lack of sufficient fraud examples by effectively creating a context within which even rare fraudulent patterns can be highlighted and used for training a more robust detection system. This approach not only addresses the challenge of fraud rarity but also enhances the model's ability to adapt and recognize new types of fraudulent behavior in commercial transactions. For clarity, commercial transactions may include those between commercial enterprises, between a person and a commercial enterprise, or even between two persons facilitated by a commercial enterprise, etc. The enterprise may be a financial institution or any other commercial enterprise, which for example might be one that assists a financial institution.

The innovation herein addresses the challenge of obscured fraudulent patterns primarily through its hybrid approach that blends unsupervised and supervised learning methods. This strategy effectively tackles the problem of tactics evolution and the sophistication and disguise of fraud schemes.

Firstly, by incorporating a clustering step that utilizes domain-specific rules, the system is able to segment transactions into coherent groups. This segmentation is tailored to reflect the nuanced understanding of SMEs (Subject Matter Experts) about what constitutes normal and abnormal transaction behaviors within specific contexts. This is crucial because fraudsters often adapt their strategies to avoid detection, and static models can quickly become outdated. The dynamic clustering allows the system to continually adapt to new patterns of transactions, maintaining sensitivity to emerging fraudulent tactics that might not have been previously recognized.

Secondly, the use of anomaly detection (AD) algorithms in each cluster to assign anomaly scores helps address the sophistication and disguise of certain types of fraudulent transactions. Since fraud schemes are designed to mimic legitimate activities, traditional models might fail to detect subtle discrepancies. However, by scoring transactions based on their deviation from the cluster norm, the system can detect anomalies that are indicative of fraud even when they are designed to be inconspicuous. This method enhances the model's ability to identify transactions that, while seemingly legitimate, deviate from expected patterns in subtle but critical ways.

Finally, the pseudo-labeling of transactions as fraudulent or legitimate based on predefined thresholds before employing a supervised Logistic Regression model leverages the strengths of both unsupervised and supervised approaches. This step ensures that the supervised model is trained on data that is already refined by the unsupervised steps, enhancing its accuracy and responsiveness to obscured patterns. The Logistic Regression model then acts on this curated dataset to predict and label new transactions in production, effectively reducing the impact of the ‘Curse of Delayed Performance’ by providing actionable outputs in real time or near-real time.

Thus, the present disclosure effectively addresses the challenge of obscured fraudulent patterns by using a combination of domain-informed clustering, sophisticated anomaly detection, and strategic integration of unsupervised and supervised learning, which are all tailored to continuously adapt to the evolving nature of fraudulent tactics.

The present disclosure addresses the challenge of limited data sharing among financial institutions by leveraging a hybrid approach that combines unsupervised and supervised learning methodologies, particularly tailored for environments where data is scarce and not shared across institutions. This solution directly tackles the issue of data scarcity by optimizing the use of the limited data available within a single institution, thus mitigating the need for cross-institutional data sharing.

Firstly, by using a clustering-based method and AD algorithms for unsupervised anomaly detection, the system is able to independently identify and pseudo-label potentially fraudulent transactions. This step does not rely on external data or shared insights from other institutions, thereby circumventing the challenges posed by privacy concerns and competitive interests. It allows the institution to make the most of its internal data by enhancing the detection capabilities without needing additional external data.

Secondly, the approach addresses inconsistent data standards by implementing domain-specific rules developed by Subject Matter Experts (SMEs) within the institution for both clustering and threshold setting in anomaly detection. This internal consistency ensures that the fraud detection system is robust and tailored to the specific characteristics and standards of the institution, reducing the impact of varying data standards across different organizations.

By focusing on maximizing the informational value of internally available data and reducing reliance on external data sharing, this method enhances the institution's ability to detect and respond to fraud effectively within its own operational framework. This innovation provides a strategic advantage in environments where data sharing is restricted, allowing financial institutions to improve their fraud detection capabilities independently.

The present disclosure directly addresses the challenge of delayed performance feedback in fraud detection by creating an adaptive mechanism that bridges the gap between unsupervised and supervised learning methods. Traditionally, the long delay in receiving ground-truth labels for transactions limits the ability to swiftly update and refine fraud detection models, making them less responsive to new or evolving fraudulent patterns. This often results in a higher rate of false positives and false negatives, as models cannot adapt to changes in fraud behavior quickly enough.

The present disclosure mitigates this issue by employing a hybrid approach, where initially, transactions are clustered and analyzed using unsupervised anomaly detection techniques. Each transaction within these clusters receives an anomaly score based on its relative oddity within the cluster. This scoring allows for the pseudo-labeling of transactions as either fraudulent or legitimate based on thresholds pre-defined by Subject Matter Experts (SMEs). This pseudo-labeling serves as an intermediate step, enabling the initiation of a supervised learning process much earlier than traditional methods which wait for verified labels.

By utilizing these pseudo-labeled transactions, the Logistic Regression model can be trained and deployed to predict fraud in new transactions more accurately. This approach effectively reduces the reliance on delayed feedback by using the derived labels as a proxy until confirmed fraud labels become available. The iterative refinement of the model through continuous training on newly labeled data further helps in enhancing its accuracy and adaptability.

Thus, the disclosed method enhances the capability of fraud detection systems to maintain relevance and effectiveness in a dynamic environment, reducing the adverse impacts of the ‘curse of delayed performance feedback’ by introducing a methodological innovation that enables more immediate response to emerging threats in the fraud landscape.

The present disclosure addresses the challenge of human error and oversight in fraud detection investigations by automating and refining the decision-making process. It minimizes reliance on subjective human judgment at critical stages of fraud identification, thus reducing the likelihood of oversights and errors.

Firstly, the system uses unsupervised machine learning to independently score transactions within clustered groups. This scoring is based on the transaction characteristics defined by subject matter experts (SMEs), ensuring that the anomaly detection is grounded in domain-specific knowledge. By automating the initial detection process, the system reduces the initial burden on human investigators, who often handle large volumes of transactions, thereby decreasing the chance of oversight.

Secondly, the present disclosure introduces a pseudo-labeling step where transactions are preliminarily labeled as fraudulent or legitimate based on predefined thresholds. This step serves as a preparatory filter that enhances the quality of data fed into the subsequent supervised learning model, the Logistic Regression model. By providing a more refined dataset for the supervised model, the system aids in producing more accurate predictions, which are less likely to be subject to human error during manual reviews.

The deployment of the Logistic Regression model in a production environment to continuously process new transactions ensures that the fraud detection system is dynamic and responsive. This continuous learning and adjustment process helps in maintaining the accuracy of fraud detection over time, even as transaction patterns and fraudulent tactics evolve.

Overall, by integrating unsupervised and supervised learning methodologies and automating significant parts of the fraud detection process, the disclosed system systematically reduces the space for human error and oversight, leading to more reliable and consistent identification of fraudulent transactions.

The present disclosure thus effectively tackles several pressing challenges in fraud detection systems, particularly those related to the scarcity of labeled data and the time-delay in verifying fraud labels, which are common in traditional supervised learning models. By integrating a hybrid model that combines unsupervised and supervised learning techniques, your approach innovatively circumvents the need for extensive labeled datasets, which are often hard to come by in fraud detection due to the rarity of fraudulent transactions relative to legitimate ones.

In the initial stages, the system uses unsupervised learning, specifically clustering and anomaly detection algorithms like Local Outlier Factor (LOF), to assess and score transactions based on their deviation from clustered norms. This step doesn't rely on pre-labeled examples, but instead generates a preliminary set of pseudo labels based on transaction behavior within specific clusters. These pseudo labels are crucial because they serve as initial signals for the supervised component of the model, allowing it to start learning from the data without waiting a lengthy time period, which could be months, for verified fraud labels. This is particularly advantageous in environments where timely fraud detection is critical to preventing losses.

Moreover, the hybrid approach enables the model to continuously refine its understanding and detection capabilities as new data flows in. Once the Logistic Regression model is trained on both legitimate transactions and those pseudo-labeled as fraudulent, it can be deployed to predict and score new transactions in real-time. This deployment not only provides immediate insights into potentially fraudulent transactions but also allows for ongoing model training and adjustment based on incoming data, thereby addressing the issue of ‘Curse of Delayed Performance.’

Additionally, the system's design acknowledges the possibility of data silos and the challenge of data privacy by focusing on clustering and anomaly detection at a local level (per client dataset). This ensures that sensitive data does not need to be shared or centralized, maintaining privacy and security while still benefiting from advanced fraud detection techniques. The potential for integrating anonymized data sharing frameworks or synthetic data generation can further enhance this model by providing more diverse data scenarios for training without compromising individual data integrity.

The present disclosure addresses the challenge of dependence on domain expertise by incorporating a hybrid approach that leverages unsupervised learning techniques, specifically clustering and anomaly detection algorithms like Local Outlier Factor (LOF). This method significantly reduces the need for continuous input from Subject Matter Experts (SMEs) for day-to-day operations.

In traditional systems, SMEs are often required to frequently adjust model parameters and interpret ambiguous cases, which can be time-consuming and costly. However, by using unsupervised methods to group transactions into clusters and then automatically scoring these for potential fraud, the system can independently identify suspicious transactions without SME intervention. This clustering based on SME-defined rules allows the system to capture domain knowledge once (or at least far less frequently) and apply it consistently, rather than requiring ongoing or repeated SME input.

The pseudo-labeling approach enables the logistic regression model to be trained on data that includes both legitimate transactions and those pseudo-labeled as fraudulent. This training approach not only enhances the model's ability to identify fraud but also reduces the reliance on delayed feedback from the fraud investigation process, which in traditional settings can take months and heavily relies on SME involvement to confirm fraud cases.

By implementing this more autonomous system, the operational costs associated with SMEs are reduced, and the system can scale more effectively without a corresponding increase in expert oversight. This also leads to quicker adaptations to emerging threats, as the system does not have to wait for expert review to begin identifying and responding to new patterns of fraud. Overall, the disclosed system streamlines the fraud detection process, making it more efficient and less dependent on continuous domain expertise.

The present disclosure directly addresses the regulatory and compliance challenges faced by financial institutions by offering a dynamic and flexible solution to fraud detection. This model is particularly effective in environments characterized by extremely low fraud incidence but high variability and sophistication in fraudulent tactics.

Traditional fraud detection systems often struggle with the rapid evolution of regulatory requirements and the increasingly sophisticated methods used by fraudsters. These systems typically rely heavily on large volumes of labeled data and may not adapt quickly enough to changing conditions, potentially leading to non-compliance and associated penalties.

The disclosed model overcomes these limitations by integrating unsupervised learning methods, like clustering and Local Outlier Factor (LOF) algorithms, with supervised learning through Logistic Regression. This hybrid approach allows for the continuous adaptation of the model to new fraud patterns and regulatory demands without the need for extensive labeled datasets. By initially using unsupervised techniques to identify potential fraudulent transactions and create pseudo labels, the model generates a valuable training signal from a predominantly unlabeled dataset, which is a common scenario in financial transaction data.

Furthermore, the adaptability of the model is enhanced through its ability to refine and adjust to new information rapidly. As new types of fraudulent transactions are identified and as regulations change, the model can quickly be reconfigured and retrained, ensuring compliance and reducing the risk of legal and reputational damage. This capability is crucial for maintaining the integrity of financial operations and safeguarding against the constantly evolving threats in the financial landscape.

By addressing these critical needs, the hybrid model not only improves the efficiency and effectiveness of fraud detection processes but also ensures that financial institutions can better manage compliance risks, thus offering a significant advancement over existing methods. This model's flexibility and responsiveness to regulatory changes make it a powerful tool in the arsenal against financial fraud, positioning it as a revolutionary step forward in the field.

### Margin Boundaries

Margin boundaries can be a crucial concept in the realm of machine learning, particularly in classification tasks. These boundaries, often visualized in the decision space, define regions around the decision boundary where the classifier's confidence in its predictions is relatively lower. Understanding margin boundaries, especially through the lenses of different models such as logistic regression (logit) and Support Vector Machines (SVM), provides valuable insights into how classifiers make decisions and how their precision and accuracy can be optimized.

In a classification model, the decision boundary separates different classes in the decision space. Surrounding this boundary are margin boundaries, which create a buffer zone. Instances that fall within this zone are typically those that the model finds challenging to classify with high confidence. This buffer can be critical because it highlights the areas of greatest uncertainty and informativeness.

### Support Vector Machines (SVM) and Margin Boundaries

SVMs are explicitly designed to maximize the margin between different classes. SVMs aim to find the hyperplane (or decision boundary) that maximizes the distance to the nearest data points of any class. This distance is known as the margin. The hyperplane that maximizes this margin is considered the optimal decision boundary. The instances that lie closest to the decision boundary are called support vectors. These points can be crucial because they define the margin boundaries. The SVM model adjusts its parameters to ensure that the support vectors are as far apart as possible while still correctly classifying the data points.

In practice, data is often not perfectly separable. To handle this, SVMs use a concept called soft margins, allowing some instances to fall within the margin boundaries or even be misclassified, to achieve a better overall separation of the classes. This approach balances margin maximization with classification accuracy.

### Logistic Regression (Logit) and Margin Boundaries

Logistic regression, often referred to as “logit,” is another popular classification technique. While it doesn't explicitly define margins like SVMs, the concept of margin boundaries can still be applied to understand its decision-making process. Logistic regression outputs probabilities for class membership. By applying a probability threshold (commonly 0.5), it determines the decision boundary. However, this threshold-based classification naturally creates regions of high and low confidence around the boundary. The confidence of the classification can be derived from the predicted probabilities. Instances with predicted probabilities close to the threshold (e.g., close to 0.5) lie within what can be considered a margin boundary. For example, this could be probabilities at 0.48 to 0.52, or 0.45 to 0.55, or 0.4 to 0.6, or the like. These instances are in a zone of higher uncertainty because the model isn't highly confident in assigning them to either class. The coefficients learned by the logistic regression model determine the steepness and orientation of the decision boundary. A steeper boundary (i.e., larger coefficient values) indicates that the model is more confident in its predictions, leading to narrower margin boundaries. Conversely, smaller coefficients result in a gentler slope, expanding the margin boundaries and indicating greater uncertainty in the predictions near the boundary.

### Comparing SVM and Logistic Regression Margin Boundaries

While both SVM and logistic regression aim to classify instances effectively, their treatment of margin boundaries reveals key differences and similarities:

Explicit vs. Implicit Margins: SVMs explicitly aim to maximize the margin, creating clear margin boundaries defined by support vectors. Logistic regression, on the other hand, does not explicitly create margins but implicitly has areas of high and low confidence based on the predicted probabilities and decision threshold.

Handling Uncertainty: In SVMs, instances within the margin boundaries are critical in defining the decision boundary. In logistic regression, the uncertainty is captured by the probability scores near the threshold. Both models, however, use these uncertain instances to refine their decision-making process.

Model Complexity: SVMs with non-linear kernels can create complex, non-linear decision boundaries and corresponding margin boundaries. Logistic regression, typically producing linear decision boundaries, is more straightforward but can be extended to non-linear boundaries through techniques like polynomial feature expansion.

### Importance of Margin Boundaries in Model Performance

Understanding and managing margin boundaries is essential for improving the precision and accuracy of classifiers. Training data instances near or within the margin boundaries are particularly informative. Correctly classifying these challenging instances can significantly enhance the model's performance. Therefore, focusing on these instances during training can lead to a more robust model. During model evaluation, examining instances within the margin boundaries can provide insights into where the model might be struggling. This information can be used to refine the model or adjust its parameters for better performance. In an active learning setting, selecting instances within the margin boundaries for labeling (since they are most uncertain) can help in efficiently improving the model by providing it with the most informative data points.

Margin boundaries, whether explicitly defined as in SVMs or implicitly understood in models like logistic regression, play a vital role in the performance of machine learning classifiers. They highlight areas of uncertainty and informativeness, guiding the model's learning process. By understanding and leveraging these boundaries, one can enhance a model's precision and accuracy, ensuring more reliable and robust predictions. In the intricate decision space of machine learning, managing these boundaries can be important to building effective classifiers.

### Entropy and Informativeness in Subspaces

The concepts of entropy and informativeness may be fundamental in machine learning, borrowed from information theory, to understand and quantify the uncertainty and value of data points within a decision space. These concepts help in evaluating how much information a data point provides to the model, which may be important for improving the model's learning process and its eventual performance.

Entropy, in the context of machine learning, measures the level of uncertainty or unpredictability in the data. Low-Entropy Subspaces are regions within the decision space where the outcomes are highly predictable. Instances in these subspaces are far from the decision boundary, and the model can classify them with high confidence. Since these instances do not introduce much uncertainty, they are considered to have low entropy.

Characteristics are: (1) High confidence in classification. (2) Clear distinction between classes. (3) Little variability in predictions.

### Implications:

Instances provide little new information to the model.

Useful for confirming the model's current understanding but not for improving it significantly.

High-Entropy Subspaces are located near the decision boundary, where the model finds it challenging to classify instances. The high uncertainty in these regions reflects a higher level of entropy.

### Characteristics are: (1)

Low confidence in classification. (2) Ambiguity between classes. (3) High variability in predictions.

### Implications:

Instances are highly informative.

Crucial for refining the decision boundary and improving the model's performance.

Provide significant learning opportunities for the model.

Informativeness of Subspaces pertains to the value of data points in terms of the knowledge they provide to the model. Low-Informativeness Subspaces typically coincide with low-entropy subspaces. Instances here are easily classified and do not challenge the model, offering minimal new information. Examples include redundant data points that reinforce what the model already knows, and data points that are consistently classified correctly with high confidence. Low-informativeness subspaces are primarily used to confirm the model's understanding, and may be less useful for learning new patterns or refining the decision boundary.

High-Informativeness Subspaces are often aligned with high-entropy areas. Instances in these subspaces are near the decision boundary and carry a significant amount of uncertainty, making them highly informative for the model. Examples include ambiguous data points that the model struggles to classify, and data points near the threshold where the decision boundary is not clearly defined. In model training, high-informativeness subspaces can be crucial for refining the decision boundary, and help in improving the model's accuracy and generalization by providing challenging examples.

The arrangement of these subspaces and their entropy levels directly influence the precision and accuracy of a classifier. During training, focusing on high-entropy subspaces can significantly enhance the model's learning. This is because these regions provide the most informative data points, challenging the model and leading to better refinement of the decision boundary. In active learning scenarios, selecting data points from high-entropy subspaces for labeling can make the training process more efficient. This helps ensure that the model is exposed to the most informative instances, accelerating the learning process.

Evaluating the model's performance, specifically in high-entropy subspaces, can provide insights into its robustness. A model that performs well in these regions is likely to have a well-optimized decision boundary and better generalization capabilities. Understanding how the model handles high-entropy subspaces can help in balancing precision (true positives over all predicted positives) and recall (true positives over all actual positives). This balance is crucial for applications where the costs of false positives and false negatives differ significantly.

A well-trained model that has learned effectively from high-entropy subspaces is likely to generalize better to new, unseen data. This is because it has been exposed to a variety of challenging instances during training, resulting in a more robust decision boundary. By focusing on high-entropy subspaces, the model may also be better equipped to handle edge cases and ambiguous instances in real-world applications, thereby improving its overall reliability.

Understanding entropy and informativeness in subspaces has several practical applications as follows. Feature Engineering: By identifying high-entropy regions, one can focus on creating new features or transforming existing ones to reduce uncertainty and improve model performance. Model Debugging: Analyzing high-entropy subspaces can help in identifying weaknesses in the model, such as areas where it consistently misclassifies instances. This can guide further model improvements. Data Collection and Labeling: In scenarios where data is scarce or labeling is expensive, focusing on high-entropy instances ensures that the most informative data points are labeled first, maximizing the value of the data collection process.

The interplay between entropy and informativeness within subspaces of the decision space is crucial for understanding and improving machine learning models. By focusing on high-entropy, high-informativeness regions, one can significantly enhance the model's learning process, leading to better performance and generalization. These concepts not only aid in model training but also in feature engineering, model debugging, and efficient data collection, making them important tools.

Classification confidence can be a critical metric in machine learning, representing the degree of certainty a model has in its predictions. It quantifies how confident the model is that a given instance belongs to a particular class. Understanding classification confidence and its implications within various subspaces of the decision space can be vital for developing robust models that perform well under a variety of conditions. High-confidence subspaces are regions within the decision space where the model exhibits a high degree of certainty in its classifications. These areas are characterized by:

Low Entropy: In high-confidence subspaces, instances have predictable outcomes with low uncertainty. This is because the features of the instances in these regions strongly indicate a specific class, making it easier for the model to make accurate predictions.

Far from the Decision Boundary: Instances that lie far from the decision boundary are usually classified with high confidence. These points are well-separated from other classes, resulting in a clear and decisive prediction by the model.

Example—Logistic Regression: In logistic regression, high-confidence subspaces are where the predicted probabilities are close to 0 or 1, far from the threshold (commonly 0.5 or around 0.5). The model is highly certain about the class membership of these instances.

Example—Neural Networks: In neural networks, the softmax function outputs a high probability for one class and very low probabilities for others in high-confidence regions. This indicates that the model is very confident about its prediction.

Low-confidence subspaces are regions near the decision boundary where the model's predictions are less certain. These areas are characterized by:

High Entropy: Low-confidence subspaces exhibit high uncertainty because the features of the instances do not strongly indicate a specific class. The model struggles to confidently classify these instances.

Close to the Decision Boundary: Instances near the decision boundary lie in zones of higher uncertainty, as small changes in the features can lead to different classifications. These instances are critical for refining the model's decision-making capabilities.

Example—Logistic Regression: In logistic regression, low-confidence subspaces are where the predicted probabilities are close to the threshold (around 0.5, as discussed herein). The model is uncertain whether an instance should be classified into one class or another.

Example—Support Vector Machines (SVMs): In SVMs, instances within the margin boundaries (support vectors) are in low-confidence regions. These instances are pivotal in defining the decision boundary and improving the model's accuracy.

Several techniques can be employed to improve classification confidence, especially in low-confidence subspaces. Combining predictions from multiple models can enhance overall confidence. Techniques such as bagging (Bootstrap Aggregating) and boosting (e.g., AdaBoost) aggregate the outputs of different models to produce a more reliable prediction. Methods such as Platt scaling or isotonic regression can be used to adjust the predicted probabilities to better reflect the true likelihood of each class, thus improving confidence in the predictions. In active learning, the model actively selects the most uncertain instances (typically those in low-confidence subspaces) for labeling by an oracle. This targeted approach ensures that the model learns from the most informative data points, improving its overall performance and confidence. Creating additional training data through techniques like oversampling, SMOTE (Synthetic Minority Over-sampling Technique), or data augmentation can help the model better learn the underlying patterns and improve confidence in its predictions. Techniques such as L1 and L2 regularization can help prevent overfitting, leading to more generalized decision boundaries and improved confidence in predictions. By penalizing large coefficients, regularization helps maintain simpler, more interpretable models that perform better on unseen data. Proper tuning of hyperparameters (e.g., learning rate, regularization strength) can significantly impact the model's performance. Techniques like grid search, random search, or Bayesian optimization can help find the optimal hyperparameters that enhance classification confidence.

The arrangement and characteristics of high-confidence and low-confidence subspaces significantly influence the precision and accuracy of a classifier. Precision is the proportion of true positive predictions out of all positive predictions. High-confidence subspaces contribute to higher precision as the model is more certain about its positive classifications. Focusing on improving confidence in low-confidence subspaces can help reduce false positives, thereby enhancing precision. Accuracy measures the overall correctness of the classifier's predictions. It is the ratio of correctly predicted instances (both true positives and true negatives) to the total instances. A well-defined decision boundary that incorporates high-confidence subspaces effectively while learning from low-confidence subspaces leads to improved accuracy.

Scatter plots with color-coding based on classification confidence can provide an intuitive view of high and low-confidence instances. This visualization may be particularly useful in lower-dimensional spaces.

Understanding and managing classification confidence and its associated subspaces can be essential for developing robust machine learning models. High-confidence subspaces indicate areas where the model performs well, while low-confidence subspaces highlight regions that require further attention. By leveraging techniques to improve classification confidence and visualizing these subspaces, practitioners can enhance model precision, accuracy, and overall performance. This comprehensive understanding not only aids in better model design but also in interpreting and refining model behavior for practical, real-world applications.

The decision space and its various subspaces form a complex ecosystem that underpins the functionality of machine learning classifiers. Understanding the interplay between decision boundaries, entropy, informativeness, and classification confidence within these subspaces is crucial for developing robust, accurate, and precise models. This comprehension not only aids in better model design but also in interpreting model behavior and its implications in real-world applications.

### Margin-Based Learning Theory

Support Vector Machines (SVM): In SVM, the optimization process finds the hyperplane that maximizes the margin between two classes. The decision boundary is defined by support vectors, which are the data points closest to this boundary. These points are critical because they determine the optimal hyperplane. Thus, transactions with scores around the midpoint are analogous to support vectors, as they lie near the decision boundary and provide the most information for refining the model.

### Information Theory

Shannon Entropy: Entropy measures uncertainty in information theory. For a given set of outcomes, high entropy indicates high uncertainty, meaning that the data point is more informative. Transactions with LOF scores around the midpoint have higher entropy, indicating they are more uncertain and thus carry significant information. This makes them valuable for refining the model.

### Active Learning Theory

Uncertainty Sampling: In active learning, the most uncertain samples are often the most informative for model improvement. These samples are those where the model is least confident, typically with scores near the midpoint. By selecting and learning from these uncertain samples, the model can significantly improve its decision-making process.

Combining these theories, the present disclosure asserts that the transactions with AD scores in the middle range around 0.5± a small delta, although less reliable for immediate pseudo-labeling due to higher uncertainty, carry significant information for model refinement. This is because they lie near the decision boundary (as in SVM), have higher entropy (as per Shannon Entropy), and are most informative for model improvement (as per Uncertainty Sampling in Active Learning). Without being bound by theory, this theoretical basis justifies the assumption and highlights the importance of these uncertain transactions in the iterative self-training process.

### Workflow Overview

In this approach, the multi-stage machine-learning fraud detection system of the present disclosure starts with a dataset generally consisting entirely of unlabeled transactions. To address the labeling challenge, the system employs a pseudo-labeling technique, creating initial pseudo-ground truth labels based on the Local Outlier Factor (LOF) scores or anomaly scores. These scores range from 0 to 1 and are used to assess the likelihood of transactions being fraudulent. This process is iteratively refined using a self-training approach that minimizes potential errors over iterations.

The decision boundary separates different classes in a classification problem. In the context of fraud detection, it separates fraudulent from legitimate transactions. The decision boundary is initially undefined in a fully unlabeled dataset. Through pseudo-labeling and iterative self-training, the boundary is gradually learned and refined, starting from transactions with the most confident scores (near 0 or 1) and progressively incorporating more uncertain but informative transactions.

### Detailed Process

### Initial Clustering and LOF Scoring

The dataset is partitioned into clusters based on domain-specific logic. Within each cluster, the LOF algorithm is applied to assign anomaly scores to transactions. These scores indicate the degree to which each transaction is considered an outlier.

### Pseudo-Labeling

Transactions with high and low AD scores are initially pseudo-labeled as fraudulent or legitimate, respectively. These pseudo-labels serve as the initial pseudo-ground truth for the logistic regression model.

### Model Training and Iterative Refinement:

A logistic regression model is trained using the pseudo-labeled data. The model is then used to score the remaining unlabeled transactions. The most confident new pseudo-labels are added to the training set, and the process repeats. This iterative refinement continues, progressively incorporating more transactions near the decision boundary, until all transactions are labeled.

### Convergence and Error Minimization

The iterative process aims to minimize the labeling error by leveraging the principles of uncertainty, informativeness, and decision boundary ideation. High-confidence pseudo-labels are initially used to establish a robust starting point. Over successive iterations, the model incorporates more uncertain yet informative transactions, improving its ability to accurately distinguish between fraudulent and legitimate transactions. This process converges when there are no more transactions to label, indicating that the model has effectively learned the decision boundary.

This self-training approach is a sophisticated application of semi-supervised learning principles, adapted to work with entirely unlabeled data through iterative pseudo-labeling. By strategically leveraging the LOF scores to create initial pseudo-ground truth labels, and progressively refining these labels through iterative model training and evaluation, the process ensures robust convergence and minimal error. The integration of uncertainty, informativeness, and decision boundary ideation provides a theoretically sound framework for achieving high accuracy in the absence of initial ground-truth labels.

Theorem: Iterative Self-Training Process Converges to a Solution that Minimizes Labeling Error

### Proof

### Initialization

Let D_{L}(0)=D_{L} and D_{U}(0)=D_{U} (where D_{L} stands for the dataset of labeled transactions and D_{U} stands for the dataset of unlabeled transactions).

### Iteration Step:

At iteration t, D_{L}(t) and D_{U}(t). Apply the following steps:

### Clustering and Anomaly Detection:

Cluster D_{U}(t) and compute anomaly scores sₖ(t)(trxᵢ) for (trxᵢ∈Cₖ)

### Pseudo-Labeling

Identify high-confidence and low-confidence transactions and update the labeled set:

$${D}_{L} ( t + 1 ) = {D}_{L} ( t ) ⋃ Uk ( {D}_{{F}_{k}} ( t ) ⋃ {D}_{{L}_{k}} ( t ) )$$

### Update the Unlabeled Set

$${D}_{U} ( t + 1 ) = {D}_{U} ( t ) - ( {D}_{{F}_{k}} ⋃ {D}_{{L}_{k}} )$$

### Model Training:

Train the logistic regression model

$$\hat{y} = σ ( {β}^{T} x ) = \frac{1}{1 + {e}^{- {β}^{{T}_{x}}}} ,$$

### on D_{L}(t+1).

### Convergence

Define the labeling error E(t) at iteration t as the sum of misclassification errors for the labeled set D_{L}(t). Since each iteration pseudo-labels, the most confident transactions, the error E(t) decreases monotonically: E(t+1)≤E(t). As the iterations proceed, the number of unlabeled transactions decreases. The process terminates when D_{U}(t)=Ø (is empty) or E(t) stabilizes.

### Minimal Error

By construction, high-confidence pseudo-labeling reduces the likelihood of incorrect labels. Assuming the logistic regression model is well-calibrated and the LOF scores are reliable, the iterative process converges to a minimal error solution where D_{L}(T) (for some T) approximates the true labeling of the entire dataset.

### Conclusion

The semi-supervised self-training approach, combined with contextual anomaly detection, effectively extends the labeled dataset with high-confidence pseudo-labels, iteratively improving the model and minimizing labeling error. The process leverages domain-specific clustering and LOF scores, ensuring robust performance and convergence to an accurate labeling solution. It should be understood that this theory, and all theories noted herein, are not to be considered binding and may be partially or entirely incorrect. The disclosure should be based on the descriptions of the selected processes and system features herein, rather than the theories behind the foregoing.

### Algorithmic Procedural Sequence

Consider a dataset D consisting of n transactions: {trx₁, trx₂, . . . , trxₙ}. The system starts with a subset of this data, D_{L} (labeled), and the remaining subset, D_{U} (unlabeled). The goal is to extend the labeled dataset by pseudo-labeling the unlabeled transactions using a semi-supervised learning approach, eventually training a model that minimizes the error in labeling.

### Clustering and Anomaly Detection:

Partition the dataset D_{U} into k clusters based on domain-specific logic: {C₁, C₂, . . . , Cₖ}.

Apply AD algorithm within each cluster Cₖ to compute anomaly scores for transactions. Let the anomaly score of transaction trxᵢ in cluster Cₖ be sₖ(trxᵢ)

### Pseudo-Labeling:

For each cluster Cₖ:

Identify transactions with high-confidence anomaly scores and label them as fraud:

D_{F}_{ₖ}={trxᵢ∈Cₖ|sₖ(trxᵢ)≥θ_{F}}, where θ_{F} is a threshold parameter (e.g., 0.8) used to identify high-confidence anomaly scores for pseudo-labeling transactions as fraud.

Identify transactions with low-confidence anomaly scores and label them as legitimate:

D_{L}_{ₖ}={trxᵢ∈Cₖ|sₖ(trxᵢ)≤θ_{L}}, where θ_{L} is a threshold parameter (e.g., 0.2) used to identify high-confidence anomaly scores for pseudo-labeling transactions as legitimate.

Transactions with intermediate scores sₖ(trxᵢ) in the range [0.5−δ, 0.5+δ] remain unlabeled (where δ is the interval, e.g., 0.3):

$${D}_{{U}_{k}} = \{ t r {x}_{i} ∈ {C}_{k} \vert 0.5 - δ < {s}_{k} ( t r {x}_{i} ) < 0.5 + δ \}$$

### Training the Model:

Combine the pseudo-labeled datasets: D_{P}=Uk(D_{F}_{ₖ}∪D_{L}_{ₖ}), where Uk indicated union across all k clusters, and D_{P} stands for the dataset of all transactions with pseudo labels.

Train a logistic regression model using D_{P},

$$\hat{y} = σ ( z ) = \frac{1}{1 + {e}^{- z}} ; \hat{y} = σ ( {β}^{T} x ) = \frac{1}{1 + {e}^{- {β}^{{T}_{x}}}} ,$$

where x is a transaction, β is a vector of coefficients, and ŷ is a probability that transaction x is fraud.

### Iterative Pseudo-Labeling:

Use the trained logistic regression model to assign scores to the unlabeled transactions D_{U}.

Pseudo-label transactions with high and low confidence scores and add them to the labeled set.

Repeat the process until no unlabeled data remains or until convergence criteria are met.

Assumption: The LOF scores are effective in distinguishing fraudulent and legitimate transactions within each cluster, especially for high and low scores, which tend to be more accurate, while scores in the middle range around 0.5±δ are less reliable.

Explanation: High and low LOF scores provide clear indications of fraud or legitimacy, resulting in low uncertainty. Because of this low uncertainty, the present disclosure relies more on the reliability of these scores. In contrast, scores in the middle range (around 0.5±δ) indicate higher uncertainty, making them less reliable for immediate pseudo-labeling. However, these uncertain transactions carry more information for model refinement, as they lie near the decision boundary and can help the model learn to better distinguish between fraudulent and legitimate transactions.

The present disclosure aids substantially in the technical field of fraud detection, by improving the ability of machine learning systems to be trained using entirely unlabeled transaction data. Implemented on a processor in communication with a database, the multi-stage machine-learning fraud detection system disclosed herein provides practical improvements in the accuracy of the machine learning model (particularly for transactions close to the decision boundary), as well as practical improvements on the amount of computer time, human labor, energy, and money required to train the machine learning model. This streamlined approach transforms unlabeled data into labeled data via an iterative process, without the normally routine need to have a human subject matter expert label the data manually. This unconventional approach improves the functioning of the fraud management computer system, by improving the training and functioning of the fraud detection machine learning model, thus also reducing energy consumption and the greenhouse gas emissions associated therewith.

The multi-stage machine-learning fraud detection system may be implemented as a process at least partially viewable on a display, and operated by a control process executing on a processor that accepts user inputs from a keyboard, mouse, or touchscreen interface, and that is in communication with one or more databases. In that regard, the control process performs certain specific operations in response to different inputs or selections made at different times. Certain outputs of the multi-stage machine-learning fraud detection system may be printed, shown on a display, or otherwise communicated to human operators (e.g., to a human analyst via an analyst computer operatively connected to the fraud management computer system. Certain structures, functions, and operations of the processor, display, sensors, and user input systems are known in the art, while others are recited herein to enable novel features or aspects of the present disclosure with particularity.

These descriptions are provided for exemplary purposes only, and should not be considered to limit the scope of the multi-stage machine-learning fraud detection system. Certain features may be added, removed, or modified without departing from the spirit of the claimed subject matter.

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one skilled in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

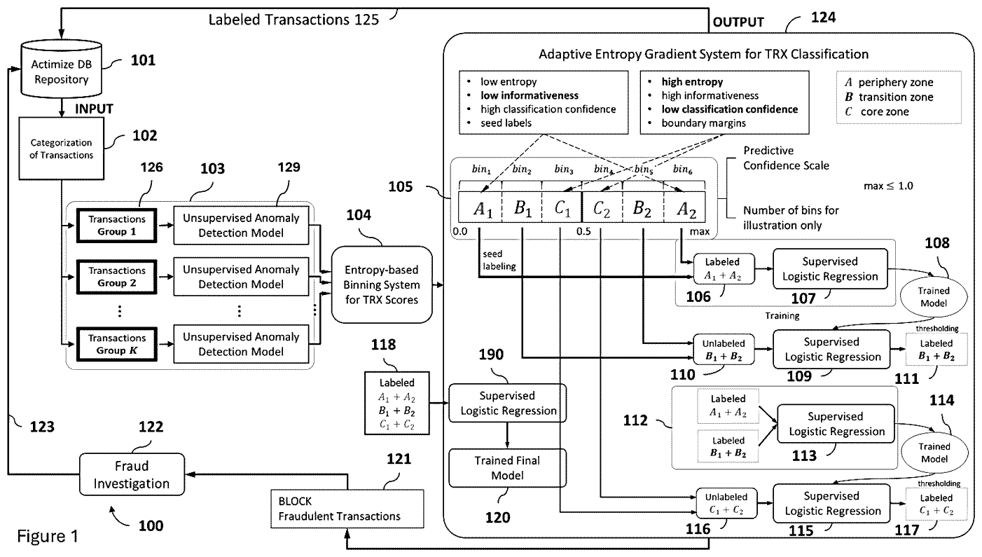

FIG. 1 is a schematic, diagrammatic representation, in block diagram form, of an example multi-stage machine-learning fraud detection system 100, in accordance with at least one embodiment of the present disclosure.

An initial step involves retrieving data in a tabular form from a transactions database or transaction repository 101, where each row of the table corresponds to unlabeled transactions, and each column represents a transaction attribute or feature.

TABLE 1
Transactions

| | f₁ | f₂ | . . . | fₖ |
|---|---|---|---|---|
| Transaction | Transaction | Transaction | . . . | Transaction |
| ID | Data | Type | | Amount |
| ID-TRX-1 | | | | |
| . . . | . . . | . . . | . . . | . . . |
| ID-TRX-N | | | | |

In a clustering step 102, the system clusters these transactions by leveraging a robust framework that utilizes rules meticulously crafted based on a deep analysis of historical transactions, statistical data, and domain-specific expertise. These rules are specifically designed to group transactions by key feature values, effectively tailoring the clusters 126 to distinct behavioral patterns inherent in the transaction data. This targeted approach ensures that each cluster 126 is not only distinct but optimally configured for the nuances of transaction behaviors observed over time.

The clustering mechanism 102 incorporates predefined rules that delineate how transactions are grouped. For example, transactions may be clustered based on the similarity in transaction amounts or geographic locations. By employing these well-defined criteria, the system of the present disclosure ensures that the clusters 126 are meaningful and that they significantly enhance the ability to detect anomalies coherently and contextually. With cluster-specific anomaly detection models 129, each transaction within these clusters 126 is subsequently assigned an anomaly score, which reflects its relative position and behavior compared to other transactions in the same cluster 126. This score can then be used in identifying outliers and potentially fraudulent activities within homogeneously grouped sets of transactions.

For example, consider a scenario where transactions are being analyzed within a financial institution. The system could use a rule that clusters transactions based on transaction amount ranges and geographical locations. For instance, Cluster A might include transactions ranging from $1,000 to $5,000, conducted within the Northeastern United States, whereas Cluster B could consist of transactions below $1,000, performed internationally.

These clusters 126 serve as a foundation for the subsequent process of unsupervised contextual anomaly detection and allow the system to pinpoint anomalies more precisely. If, for instance, a transaction in Cluster A is executed for an unusually high amount or from an unexpected geographic location, it would be flagged with a heightened anomaly score. This score highlights the transaction's deviation from the established norms of its cluster, providing critical insights that enable the proactive detection and prevention of fraud. The anomaly scores 104 are then separated into bins 105 (e.g., of equal width, although other binning strategies may be used instead or in addition.

The bins 105 include for example a bin₁ with transactions A₁ having the lowest anomaly scores (e.g., between 0.0 and 0.17), a bin₂ with transactions B₁ having the second-lowest anomaly scores (e.g., between 0.17 and 0.33), a bin₃ with transactions C₁ having the third-lowest anomaly scores (e.g., between 0.33 and 0.5), a bin with transactions C₂ having the third-highest anomaly scores (e.g., between 0.5 and 0.67), a bins with transactions B₂ having the second-highest anomaly scores (e.g., between 0.67 and 0.84), and a bin₆ with transactions A₂ having the highest anomaly scores (e.g., between 0.84 and 1.0). Other numbers and sizes of bins may be used instead or in addition.

In a first pseudo-labeling step 106, the transactions A₁ are labeled as legitimate, and the transactions A₂ are labeled as fraudulent. It is noted that there may be significantly more transactions in group A₁ than in group A₂, owing to the relative scarcity of fraud in commercial transactions. These pseudo-labeled transactions 106 are then used in a training step 107 (e.g., a supervised logistic regression) to produce a first trained model 108.

Next, the unlabeled transactions 110 in groups B₁ and B₂ are fed to the first trained model 108 in an inference step 109, yielding labels 111 for these transactions as either legitimate or fraudulent. Again, there may be many more legitimate transactions than fraudulent ones in these groups. However, because the transactions B₁ and B₂ have higher entropy and higher informativeness than the transactions A₁ and A₂, the labeling of B₁ and B₂ transactions creates training data that can be used to train a more accurate model.

Thus, in an additional training step 112, the labeled data 106 for groups A₁ and A₂, and the labeled data 111 for groups B₁ and B₂, are then used (e.g., in a supervised logistic regression 113) to produce a second trained model 114.

Next, the unlabeled transactions 116 in groups C1 and C2 are fed to the second trained model 114 in an inference step 115, yielding labels 117 for these transactions as either legitimate or fraudulent. Again, there may be many more legitimate transactions than fraudulent ones in these groups. However, because the transactions C₁ and C₂ have higher entropy and higher informativeness than the transactions B₁ and b₂, the labeling of C₁ and C₂ transactions creates training data that can be used to train a still more accurate model with a clearly defined decision boundary.

Thus, in an additional training step 190 (e.g., a supervised logistic regression), the fully labeled dataset 118 (containing labeled data 106 for A₁ and A₂, labeled data 111 for B₁ and B₂, and labeled data 117 for C₁ and C₂) is used to produce a third trained machine learning model 120, which can be used in an inference mode by an active entropy gradient system for transaction classification 124, to identify new incoming transactions as either legitimate or fraudulent.

In a blocking step 121, the system 100 can then be used to block transactions identified by the system 124 as fraudulent. Blocked transactions may then be forwarded to an analyst computer for fraud investigation 122, yielding a label 123 for the transaction as either confirmed legitimate or confirmed fraudulent. This label 123, along with labeled transactions 125 output from the system 124, can then be added to the transactions database or transaction repository 101 to help train additional models in the future.

Although FIG. 1 shows transactions being divided into six bins for the training of three successive machine learning models, it should be understood that the same principles described above may be used to divide the transactions into 4 bins for the training of two successive models, or eight bins for the training of four successive models, etc. Indeed, any number n of successive models may be trained by dividing the transactions into n×2 bins and following the steps described above. It is noted that, because the training process described in FIG. 1 does not require any labeled data at all, it can be performed regularly (e.g., monthly, weekly, or even daily) on fresh transaction data, to keep pace with changing tactics on the part of fraudsters, with no requirement for human supervision, and with a greatly reduced computer time over what would be required with human analysts in the loop.

Block diagrams are provided herein for exemplary purposes; a person of ordinary skill in the art will recognize myriad variations that nonetheless fall within the scope of the present disclosure. For example, any of the steps described herein may optionally include an output to a user of information relevant to the step, and may thus represent an improvement in the user interface over existing art by providing information (whether static or dynamically updated) that is not otherwise available.

Similarly, block diagrams may show a particular arrangement of components, modules, services, steps, processes, or layers, resulting in a particular data flow. It is understood that some embodiments of the systems disclosed herein may include additional components, that some components shown may be absent from some embodiments, and that the arrangement of components may be different than shown, resulting in different data flows while still performing the methods described herein.

Before continuing, it should be noted that the examples described above are provided for purposes of illustration, and are not intended to be limiting. Other devices and/or device configurations may be utilized to carry out the operations described herein.

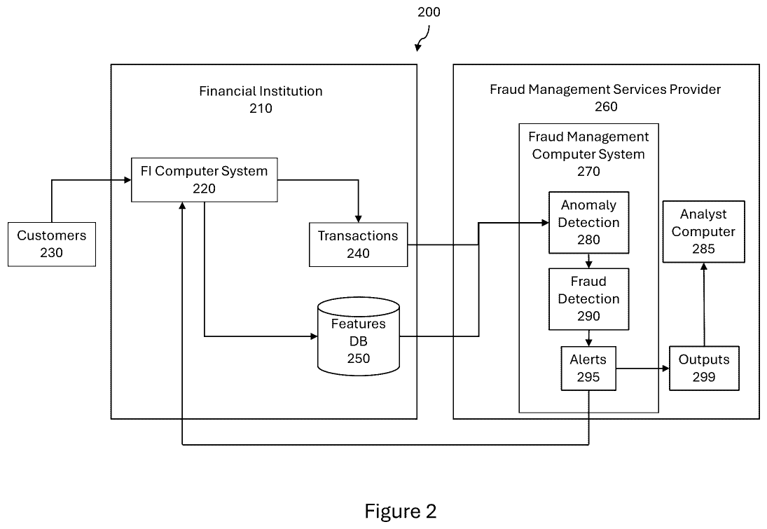

FIG. 2 is a schematic, diagrammatic representation, in block diagram form, of an example computing system architecture 200, in accordance with at least one embodiment of the present disclosure. The computing system architecture 200 includes a financial institution 210 (e.g., a bank, credit union, credit card company, etc.) in operative communication with a fraud management services provider 260. The financial institution (FI) 210 includes an FI computer system 220 which receives input from customers 230 to generate transactions 240. The transactions 240 and customers 230 each have features that may be stored in a features database 250. The fraud management services provider 260 includes a fraud management computer system or fraud management server 270, which receives transactions 240 and features 250 into an anomaly detection model 280, whose outputs are passed to a fraud detection model 290. For transactions determined to be fraudulent, the fraud management computer system can generate alerts, which include reports and other outputs 299 that can be passed to an analyst computer 285 for investigation. The alerts 295 can also be passed back to the FI computer system 220 to, for example, block the fraudulent transaction so that money is prevented from fraudulently moving from one account or location to another account or location. A person of ordinary skill in the art would appreciate that the financial institution computer system 210, the fraud management computer system 270, and the operative links between them each constitute a particular machine that provides functionality not available in a generic computer.

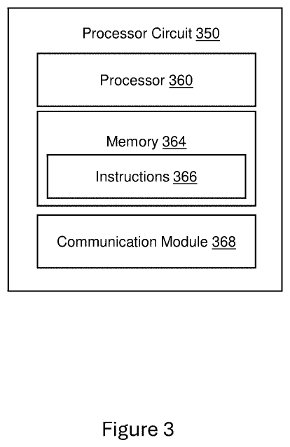

FIG. 3 is a schematic diagram of a processor circuit 350, according to embodiments of the present disclosure. The processor circuit 350 may be implemented in components of the system 100, or other devices or workstations (e.g., third-party workstations, network routers, etc.), or on a cloud processor or other remote processing unit, as necessary to implement the method. As shown, the processor circuit 350 may include a processor 360, a memory 364, and a communication module 368. These elements may be in direct or indirect communication with each other, for example via one or more buses.

The processor 360 may include a central processing unit (CPU), a digital signal processor (DSP), an ASIC, a controller, or any combination of general-purpose computing devices, reduced instruction set computing (RISC) devices, application-specific integrated circuits (ASICs), field programmable gate arrays (FPGAs), or other related logic devices, including mechanical and quantum computers. The processor 360 may also comprise another hardware device, a firmware device, or any combination thereof configured to perform the operations described herein. The processor 360 may also be implemented as a combination of computing devices, e.g., a combination of a DSP and a microprocessor, a plurality of microprocessors, one or more microprocessors in conjunction with a DSP core, or any other such configuration.

The memory 364 may include a cache memory (e.g., a cache memory of the processor 360), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an embodiment, the memory 364 includes a non-transitory computer-readable medium. The memory 364 may store instructions 366. The instructions 366 may include instructions that, when executed by the processor 360, cause the processor 360 to perform the operations described herein. Instructions 366 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The communication module 368 can include any electronic circuitry and/or logic circuitry to facilitate direct or indirect communication of data between the processor circuit 350, and other processors or devices. In that regard, the communication module 368 can be an input/output (I/O) device. In some instances, the communication module 368 facilitates direct or indirect communication between various elements of the processor circuit 350 and/or the system 100. The communication module 368 may communicate within the processor circuit 350 through numerous methods or protocols. Serial communication protocols may include but are not limited to United States Serial Protocol Interface (US SPI), Inter-Integrated Circuit (I²C), Recommended Standard 232 (RS-232), RS-485, Controller Area Network (CAN), Ethernet, Aeronautical Radio, Incorporated 429 (ARINC 429), MODBUS, Military Standard 1553 (MIL-STD-1553), or any other suitable method or protocol. Parallel protocols include but are not limited to Industry Standard Architecture (ISA), Advanced Technology Attachment (ATA), Small Computer System Interface (SCSI), Peripheral Component Interconnect (PCI), Institute of Electrical and Electronics Engineers 488 (IEEE-488), IEEE-1284, and other suitable protocols. Where appropriate, serial and parallel communications may be bridged by a Universal Asynchronous Receiver Transmitter (UART), Universal Synchronous Receiver Transmitter (USART), or other appropriate subsystem.

External communication (including but not limited to software updates, firmware updates, preset sharing between the processor and central server, etc.) may be accomplished using any suitable wireless or wired communication technology, such as a cable interface such as a universal serial bus (USB), micro USB, Lightning, or Fire Wire interface, Bluetooth, Wi-Fi, ZigBee, Li-Fi, or cellular data connections such as 2G/GSM (global system for mobiles), 3G/UMTS (universal mobile telecommunications system), 4G, long term evolution (LTE), WiMax, or 5G. For example, a Bluetooth Low Energy (BLE) radio can be used to establish connectivity with a cloud service, for transmission of data, and for receipt of software patches. The controller may be configured to communicate with a remote server, or a local device such as a laptop, tablet, or handheld device, or may include a display capable of showing status variables and other information. Information may also be transferred on physical media such as a USB flash drive or memory stick.

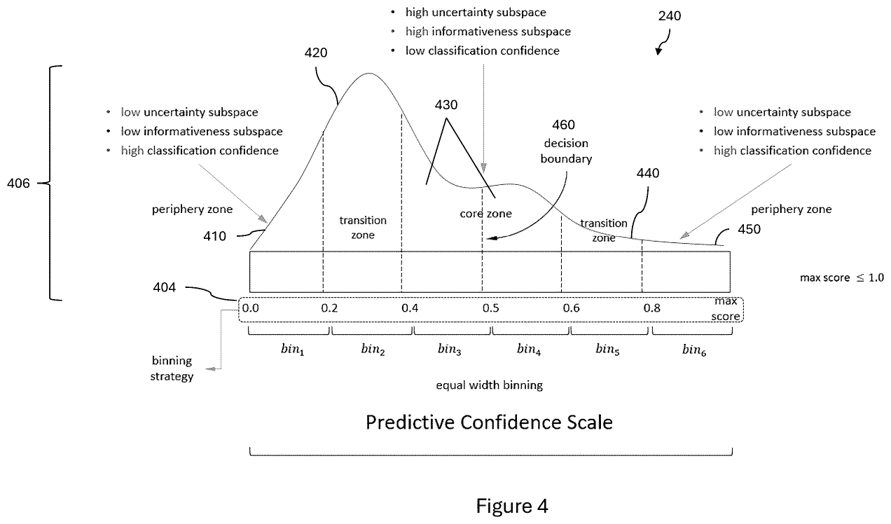

FIG. 4 is a graphical representation of a group of transactions 240, in accordance with at least one embodiment of the present disclosure. The transactions 240 are divided into bins 404 based on their risk scores, anomaly scores, or Local Outlier Factor (LOF) scores. A Y-axis 406 denotes the number of transactions 240 that occur in each bin.

In the example shown in FIG. 4, bin contains the transactions 240 with the smallest risk (e.g., the lowest chance that the transaction is fraudulent). These transactions fall within a lower periphery zone 410, which is a subspace having low uncertainty, low informativeness, and high classification confidence. Next, bin₂ contains transactions with the second-lowest risk scores, and forms a lower transition zone 420, a subspace having moderate uncertainty, moderate informativeness, and moderate classification confidence. Bin₃ and bin₄, with the third-lowest and third-highest risk scores, fall immediately on either side of the decision boundary 460, and thus form a core zone 430, a subspace having high uncertainty, high informativeness, and low classification confidence. Bins has the second-highest risk scores, and thus forms an upper transition zone 440, a subspace having moderate uncertainty, moderate informativeness, and moderate classification confidence. Bin₆ contains the transactions with the highest risk scores, and thus forms an upper periphery zone 450, a subspace with low uncertainty, low informativeness, and high classification confidence.

As can be seen in the graph, the vast majority of transactions are non-fraudulent and thus are sorted into bins 1-3, with only a small minority occurring in bin₆ (e.g. the “almost certainly fraudulent” bin). This highlights the challenges of training a machine learning model to identify fraudulent transactions, as the majority of data points in the set fall into a single class (non-fraudulent), and a significant number of data points (e.g., more than 25%) fall close to the decision boundary 460.

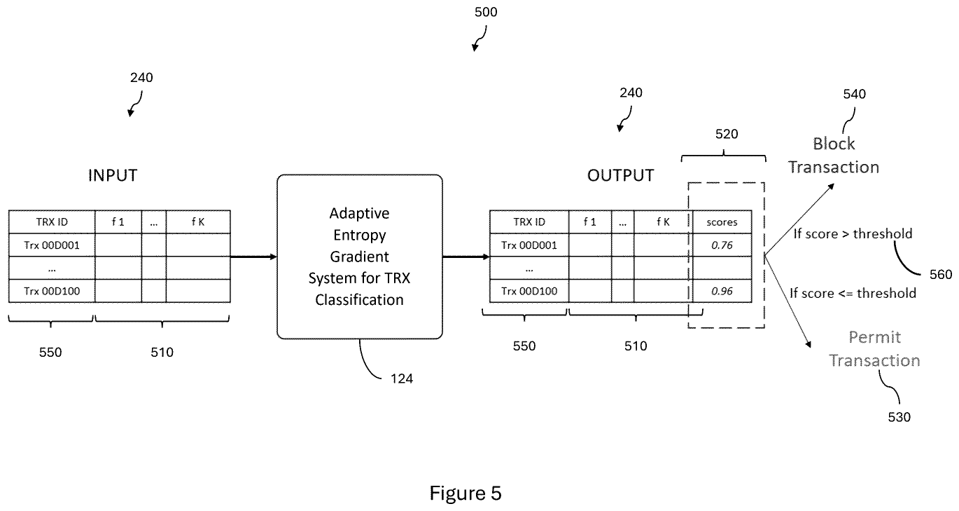

FIG. 5 is a schematic, diagrammatic representation, in block diagram form, of an example multi-stage machine-learning fraud detection system 500, in accordance with at least one embodiment of the present disclosure. In the example shown in FIG. 5, incoming transactions 240 each include a transaction ID 550 and a number of features 510. The transactions 240 are fed to an adaptive entropy gradient system for transaction classification 124 which, in inference mode, outputs the same transaction IDs 550 and features 510, along with a fraud score 520 that may for example be a value between 0 and 1 representing the fractional or percentage chance that the transaction belongs to the “fraudulent” class rather than the “legitimate class”. This is different than the anomaly score generated by the anomaly detection model 129, although in some cases it may have a similar value. The fraud score 520 is then compared against a threshold 560 (e.g., 0.8). If the fraud score 520 exceeds the threshold 560, then a blocking step 540 blocks the transaction from occurring. If the fraud score 520 is less than the threshold 560, then a permitting step 530 permits the transaction (e.g., does not block the transaction from occurring).

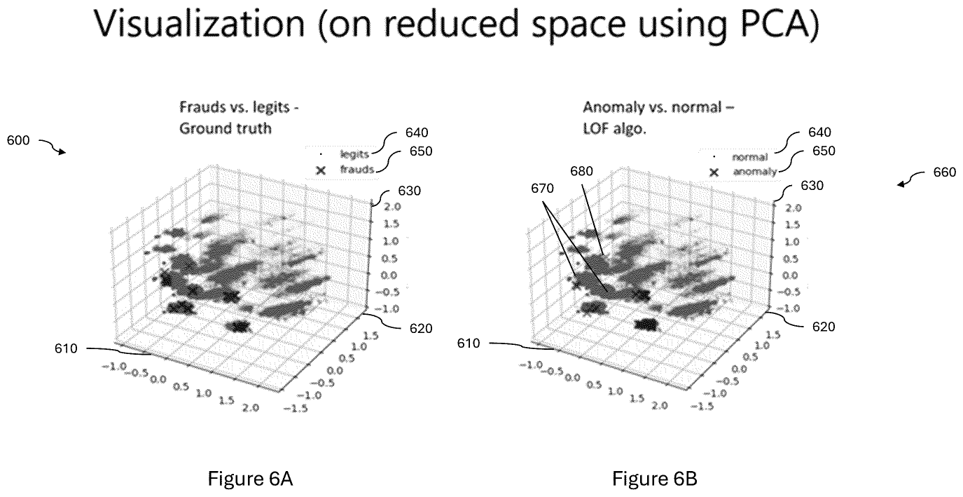

FIG. 6A is a graphical representation 600 of ground-truth legitimate transactions 640 and fraudulent transactions 650, in accordance with at least one embodiment of the present disclosure. An X-axis 610, Y-axis 620, and Z-axis 630 represent a reduced-dimensionality space. Each transaction 640, 650 occupies a location in a multidimensional “feature space” having one axis or dimension for each feature used to identify the transaction. This can be tens or even hundreds of dimensions. However, through principal component analysis (PCA), this multidimensional space can be reduced to three dimensions for case of display and understanding. In the example shown in FIG. 6A, there are 14 fraudulent transactions, and many thousands of legitimate transactions.

FIG. 6B is a graphical representation 660 of machine-learning-classified legitimate transactions 640 and fraudulent transactions 650, in accordance with at least one embodiment of the present disclosure. The 3-dimensional space and the transactions are the same as in FIG. 6A, but the classification of which transactions are legitimate 640 and which are fraudulent 650 is made by the multi-stage machine-learning fraud detection system of the present disclosure. As can be seen in the graph, 9 of the 14 fraudulent transactions are detected, along with 5 false negatives 670 and one false positive 680. For a machine-learning model trained on only a very small number of frauds, against a background of thousands of legitimate transactions, this represents a very high accuracy and precision, with a very discriminating decision boundary, achieved without the need for a human analyst to label any of the training data, by a training process that can be performed monthly, weekly, or even daily, to keep pace with emerging threats.

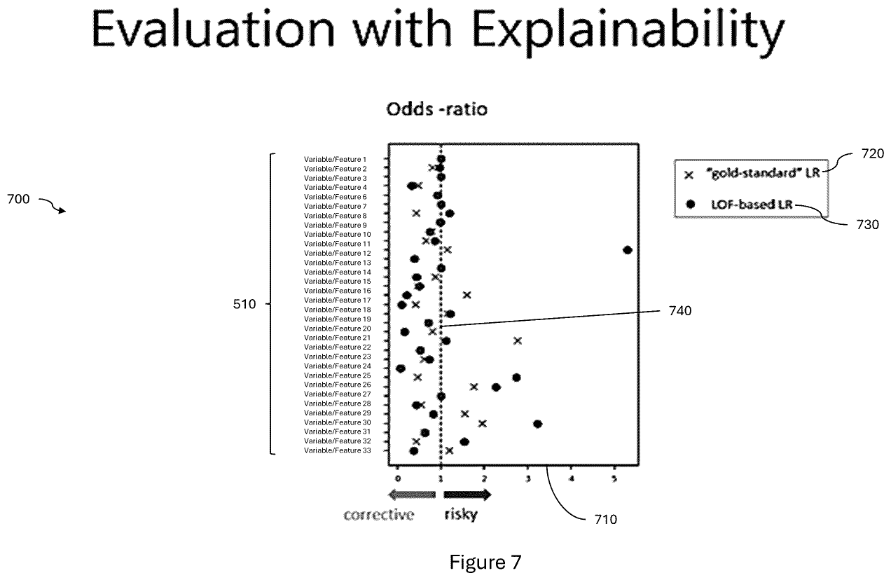

FIG. 7 is a graphical representation of 33 variables or features 510 with respect to a decision boundary 740 for a particular exemplary fraudulent transaction, in accordance with at least one embodiment of the present disclosure. Values of an odds ratio 710 for the 33 variables 510 are either corrective (e.g., less than 1), indicating that the transaction is not risky or not likely to be fraudulent, or risky, indicating that the transaction is risky or likely to be fraudulent. Data points 720 marked with an “X” represent the “gold standard” logistic regression, whereas data points 730 marked with a circular dot represent a logistic regression performed according to the present disclosure. As can be seen in the graph, in a majority of cases, variables identified as risky by the gold standard are also identified as risky by the multi-stage machine-learning fraud detection system, thus demonstrating that the disclosed method of multi-stage training of the machine learning model is effective at identifying fraudulent transactions.

It is noted that feature engineering plays a significant role in shaping the decision boundary 740. Selecting the most relevant features ensures that the decision boundary is influenced by the most important aspects of the data, leading to better model performance. Transforming features, such as through polynomial expansion or log transformation, can help in creating a more meaningful decision boundary, especially in cases where the relationship between features and the target variable is non-linear.

Visualizing the decision boundary can provide intuitive insights into the model's behavior, particularly in lower-dimensional spaces. This can help in understanding model strengths and limitations, guiding further tuning and adjustment. In practice, such visualization can be helpful during model evaluation, offering a tangible depiction of how well the model might perform in operational settings.

For example, in a two-dimensional feature space, plotting the decision boundary along with margin boundaries (in the case of SVMs) can visually demonstrate how well the model separates the classes and handles instances close to the boundary. The positioning and shape of the decision boundary may be important for the effectiveness of a classifier. Factors such as the training data, model complexity, and regularization techniques play crucial roles in determining this boundary. By maximizing the margin and optimally placing the decision boundary, a model can achieve a higher true positive rate and true negative rate, enhancing its overall precision and accuracy. Understanding and optimizing these aspects are essential for developing robust machine learning models that perform well on both training and novel, previously unseen data, as shown in the following tables:

TABLE 2
Training Data Detection Rate

| | “Gold Standard” Linear | Linear Regression based |
|---|---|---|
| Alert Rate | Regression | on Anomaly Detection |
| 1 | 44 | 42 |
| 3 | 62 | 53 |
| 5 | 71 | 64 |
| 10 | 98 | 91 |

TABLE 3
Test Data Detection Rate

| | “Gold Standard” Linear | Linear Regression based |
|---|---|---|
| Alert Rate | Regression | on Anomaly Detection |
| 1 | 75 | 75 |
| 3 | 87 | 87 |
| 5 | 87 | 100 |
| 10 | 100 | 100 |

TABLE 4
Training Data Value Detection Rate

| | “Gold Standard” Linear | Linear Regression based |
|---|---|---|
| Alert Rate | Regression | on Anomaly Detection |
| 1 | 11 | 11 |
| 3 | 54 | 41 |
| 5 | 62 | 77 |
| 10 | 99 | 97 |

TABLE 5
Test Data Value Detection Rate

| | “Gold Standard” Linear | Linear Regression based |
|---|---|---|
| Alert Rate | Regression | on Anomaly Detection |
| 1 | 84 | 74 |
| 3 | 92 | 92 |
| 5 | 92 | 100 |
| 10 | 100 | 100 |

Where Detection Rate is the proportion of fraudulent activities identified by the model out of all the alerts generated:

$$( \frac{\# of true detected frauds}{\# of total frauds} ) .$$

and Value Detection Rate is the proportion of fraudulent monetary value identified by the model out of the total amount of fraudulent money:

$$( \frac{amount of true detected frauds}{amount of total frauds} ) .$$

It can be seen from the results, both in training and testing, that the logistic regression model trained on the artificial labels performs very similarly to the “gold standard” logistic regression model trained on the real labels.

Due to the limited number of labels, it may not be feasible to draw definitive conclusions about the nature of the model based solely on these few labels. Therefore, the present disclosure examined the model's interpretation using odds ratios and compared these to the odds ratios of the “gold standard” model.

Over half of the model's features exhibited a direction and effect size similar to those of the “gold standard” model. Additionally, some features that showed different effects were consistent with the assumptions of the example's analysts, and made logical sense.

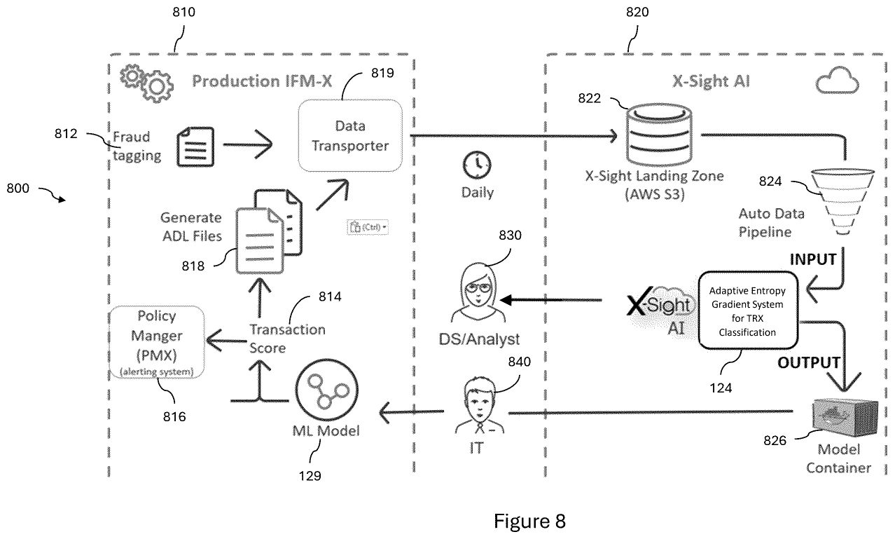

FIG. 8 is a schematic, diagrammatic representation of a software systems architecture 800, in accordance with at least one embodiment of the present disclosure. The architecture 800 includes a transaction scoring module 810. When an anomaly detection machine learning model 129 receives a transaction, it produces a transaction score 814 (e.g., a risk score, anomaly score, or local outlier factor (LOF) score), which is passed to an alerting system 816 and a file generator 818, which generates automated detection log (ADL) files, which are passed to a data transporter 819, along with fraud tags 812 (e.g., transactions labeled as fraudulent by an analyst 830). The data transporter then pushes this information to a landing zone database 822 (e.g., in daily batches, or otherwise).

The architecture 800 also includes a fraud detection module 820, which includes the landing zone database 822. An automatic data pipeline 824 transfers data (e.g., tagged and untagged transactions, along with their associated risk scores 814) from the landing zone database 822 to the adaptive entropy gradient system for transaction classification 124, whose outputs (e.g., transactions identified as fraudulent) may be sent to an analyst 830 for investigation, and to a model container 826. The model container 826 may then be received by information technology (IT) personnel, who can use it to update the anomaly detection machine learning model 129 (e.g., by using identified frauds as labeled training data for the anomaly detector).

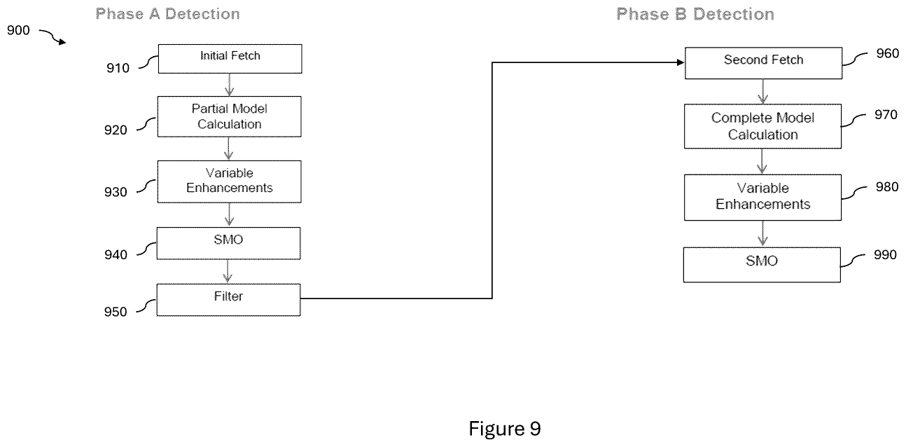

FIG. 9 is a schematic, diagrammatic representation, in flow diagram form, of an example fraud detection method 900, in accordance with at least one embodiment of the present disclosure. In some embodiments, for technical performance reasons, the detection flow for transactions may be divided into two phases, phase A and phase B. Analytics logic is run after phase A to decide whether it is necessary to run phase B. The decision not to proceed to phase B is due to two reasons: either the transaction is suspicious, or the transaction is not suspicious. If it is not yet clear if the transaction is suspicious, processing continues with phase B detection.

In step 910, Initial Fetch, the method 900 includes fetching the profiles and accumulation period data needed for the detection; for example, for a credit card, it would fetch the card profiles and device profiles and the previous activity by card set.

In step 920, Partial Model Calculation, the method 900 includes calculating custom events. This step may run analytics models, on both internal indicative features and indicative custom features. This step determines the fraud score (e.g., a value between zero and 1 that indicates the percentage chance that the transaction is fraudulent, in the opinion of the final fraud detection model).

In step 930, Variable Enhancements, the method 900 includes running the fraud detection model on phase A features. This is an exit point that analytics can use to enrich the out-of-the-box models (internal indicative features and indicative custom features) and override the risk score with the score provided by the ML model.

In step 940, structured model overlay (SMO), the method 900 includes retrieving all built-in and custom analytics features as input to be used to enhance the detection results.

The final step of the phase A model is to recommend whether or not to proceed to phase B, although the filter makes the final decision.

In step 950, Filter, the method includes deciding whether or not to perform phase B detection. This decision may for example involve a rule-based system using pre-defined, expert-based simple logic rules to filter out transactions that are assumed to be safer. Such filtration rules may be configurable and can thus be modified or turned off, depending on a clients' needs. For example, one basic filtration rule may be used to filter out transactions sent to an older beneficiary of the party (who already received payments from the party in the past), while another rule may filter out all transactions with a low dollar amount (e.g., below a predefined threshold).

In step 960, Second Fetch, the method 900 includes retrieval based on more complex queries (e.g., multiple payees per transaction, etc.).

In step 970, Complete Model Calculation, the method 900 includes running the fraud detection model using the additional internal and custom indicative features identified in step 960.

In step 980, Variable Enhancements, the method 900 includes performing more calculations based on the newly retrieved sets.

In step 990, SMO, the method 900 includes deciding the final fraud score for the transaction. This can be based on further models.

For example, using pre defined simple rules to filter out transactions that are supposed to be safer. Those filtration rules are configurable and can be modified or turned off, depending on clients' needs. As few examples—one basic filtration rule is used to filter out transactions sent to an old beneficiary of the party (who already received payments from the party in the past). Another rule will filter out all transactions with a low dollar amount (e.g., below a predefined threshold).

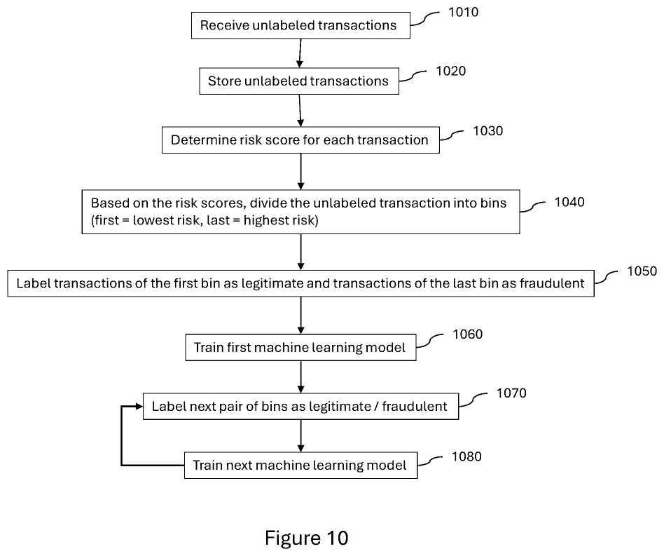

FIG. 10 is a schematic, diagrammatic representation, in flow diagram form, of an example multi-stage machine-learning fraud detection method, in accordance with at least one embodiment of the present disclosure. It is understood that the steps of method 1000 may be performed in a different order than shown in FIG. 10, additional steps can be provided before, during, and after the steps, and/or some of the steps described can be replaced or eliminated in other embodiments. One or more of steps of the method 1000 can be carried by one or more devices and/or systems described herein, such as components of the system 100, system 500, and/or processor circuit 350.

In step 1010, the method 1000 includes receiving unlabeled transactions. Execution then proceeds to step 1020.

In step 1020, the method 1000 includes storing the unlabeled transactions in a database. Execution then proceeds to step 1030.

In step 1030, the method 1000 includes determining a risk score between 0 and 1 for each transaction (e.g., with 0 representing the lowest risk). Execution then proceeds to step 1040.

In step 1040, the method 1000 includes, based on the risk scores, dividing the transactions into bins (e.g., such that the first bin includes transactions with the lowest risk scores, and the last bin or nth bin includes transactions with the highest risk scores). In an example, the bins are of equal width (e.g., 6 bins of width ⅙). Execution then proceeds to step 1050.

In step 1050, the method 1000 includes labeling transactions of the first bin as legitimate, and labeling transactions of the last bin as fraudulent, noting that there may be many more legitimate transactions than fraudulent ones. Execution then proceeds to step 1060.

In step 1060, the method 1000 includes training a first machine learning model on the labeled data. Execution then proceeds to step 1070.

In step 1070, the method 1000 includes labeling the next pair of bins (e.g., the 2^{nd} and 2^{nd} to last, the 3^{rd} and 3^{rd} to last, the nth and nth to last, etc.), such that the lower-risk bin is labeled as legitimate and the higher-risk bin is labeled as fraudulent. Execution then proceeds to step 1080.

In step 1080, the method 1000 includes training the next machine learning model on all available labeled transactions. If all transactions have been labeled, the method is now complete. Execution then proceeds to step 1090. If all transactions have not been labeled, the method returns to step 1070.

Flow diagrams are provided herein for exemplary purposes; a person of ordinary skill in the art will recognize myriad variations that nonetheless fall within the scope of the present disclosure. For example, any of the steps described herein may optionally include an output to a user of information relevant to the step, and may thus represent an improvement in the user interface over existing art by providing information (whether static or dynamically updated) that is not otherwise available.

Similarly, block diagrams may show a particular arrangement of components, modules, services, steps, processes, or layers, resulting in a particular data flow. It is understood that some embodiments of the systems disclosed herein may include additional components, that some components shown may be absent from some embodiments, and that the arrangement of components may be different than shown, resulting in different data flows while still performing the methods described herein.

Similarly, the logic of flow diagrams may be shown as sequential. However, similar logic could be parallel, massively parallel, object oriented, real-time, event-driven, cellular automaton, or otherwise, while accomplishing the same or similar functions. In order to perform the methods described herein, a processor may divide each of the steps described herein into a plurality of machine instructions, and may execute these instructions at the rate of several hundred, several thousand, several million, or several billion per second, in a single processor or across a plurality of processors. Such rapid execution may be necessary in order to execute the method in real time or near-real time as described herein. For example, to analyze thousands or millions of transactions per day, providing alerts and blocking fraudulent transactions in real time, the system may need to compute risk scores for transactions within e.g. 10 milliseconds of receipt of the transaction. Similarly, to avoid a perception of lag on the part of a user, the anomaly detection and training steps may need to be performed within e.g., 10 seconds of the time a batch of unlabeled training data is received. Such machine learning steps are not performable by a human at all, and classical arithmetic steps that produce comparable results are not performable in real time, nor indeed within a normal human lifespan of ˜100 years.

As will be readily appreciated by those having ordinary skill in the art after becoming familiar with the teachings herein, the multi-stage machine-learning fraud detection system of the present disclosure advantageously improves the functioning of the fraud detection machine learning model by training it in stages, with successively improving accuracy and precision, using a database of unlabeled transactions. Accordingly, it can be seen that the multi-stage machine-learning fraud detection system fills a long-standing need in the art, by allowing unlabeled transaction data to be used, in real time or near-real time, to train the machine learning model, without the normally routine need for a human analyst to manually label the transactions.

A number of variations are possible on the examples and embodiments described above. For example, the number of transaction clusters may be different than shown herein (e.g., there may be more or fewer than three clusters). In some embodiments, the input transactions used for training the machine learning model may all reside in a single cluster, operated on by a single anomaly detection model. In other embodiments, the input transactions may reside in e.g., four or six or ten different clusters, each with its own trained, unsupervised anomaly detection model. Once the transactions have each been assigned a risk score by the unsupervised anomaly detection model(s), they may be divided into any even number of bins, such as 4 bins, 6 bins, 8 bins, etc., with each pair of bins being used to train a successively more accurate fraud detection model. The fraud detection model may be a

The technology described herein may be applied to disciplines other than fraud detection, including but not limited to customer churn prediction, credit risk assessment, and spam email detection.

Accordingly, the logical operations making up the embodiments of the technology described herein are referred to variously as operations, steps, objects, elements, components, or modules. Furthermore, it is understood that these may occur, or be performed or arranged, in any order, unless explicitly claimed otherwise or a specific order is inherently necessitated by the claim language.

In some implementations, the fraud detection machine learning model may be a logistic regression (logit), Support Vector Machines (SVM) model, and/or an adaptive entropy gradient model, although in other embodiments, other types of leaning networks may be used instead or in addition, without departing from the spirit of the present disclosure.

All directional references e.g., upper, lower, inner, outer, upward, downward, left, right, lateral, front, back, top, bottom, above, below, vertical, horizontal, clockwise, counterclockwise, proximal, and distal are only used for identification purposes to aid the reader's understanding of the claimed subject matter, and do not create limitations, particularly as to the position, orientation, or use of the multi-stage machine-learning fraud detection system. Connection references, e.g., attached, coupled, connected, joined, or “in communication with” are to be construed broadly and may include intermediate members between a collection of elements and relative movement between elements unless otherwise indicated. As such, connection references do not necessarily imply that two elements are directly connected and in fixed relation to each other. The term “or” shall be interpreted to mean “and/or” rather than “exclusive or.” The word “comprising” does not exclude other elements or steps, and the indefinite article “a” or “an” does not exclude a plurality. Unless otherwise noted in the claims, stated values shall be interpreted as illustrative only and shall not be taken to be limiting.

The above specification, examples and data provide a complete description of the structure and use of exemplary embodiments of the multi-stage machine-learning fraud detection system as defined in the claims. Although various embodiments of the claimed subject matter have been described above with a certain degree of particularity, or with reference to one or more individual embodiments, those skilled in the art could make numerous alterations to the disclosed embodiments without departing from the spirit or scope of the claimed subject matter.

Still other embodiments are contemplated. It is intended that all matter contained in the above description and shown in the accompanying drawings shall be interpreted as illustrative only of particular embodiments and not limiting. Changes in detail or structure may be made without departing from the basic elements of the subject matter as defined in the following claims.

What is claimed is:

1. A system adapted to automatically identify suspected fraudulent transactions, the system comprising:
a fraud management server having at least one processor and a non-transitory computer readable medium operably coupled thereto, the server being in electronic communication with a computing device of a financial institution, the processor comprising a transaction repository, an anomaly detection model, and a transaction classification model, the server being in electronic communication with a database for storing a plurality of features for a plurality of transactions associated with the financial institution, the computer readable medium comprising a plurality of instructions stored in association therewith that are accessible to, and executable by, the processor, to perform operations which comprise:
receiving a plurality of unlabeled transactions, each transaction having a respective plurality of features;
storing the unlabeled transactions in the transaction repository;
with the anomaly detection model and the respective pluralities of features for the plurality of unlabeled transactions, determining a respective plurality of transaction risk scores, wherein each transaction risk score is a value between 0 and 1, wherein higher values represent a greater risk that the transaction is fraudulent;
based on the plurality of transaction risk scores, dividing the unlabeled transactions into a plurality of bins, wherein a first bin of the plurality of bins contains transactions with the lowest respective risk scores, and wherein a last bin of the plurality of bins contains transactions with the highest respective risk scores;
labeling transactions of the first bin of the plurality of bins as legitimate;
labeling transactions of the last bin of the plurality of bins as fraudulent;
with the transaction classification model and the labeled transactions of the first and last bins and their respective pluralities of respective features, training a first machine learning model;
with the trained first machine learning model and the respective pluralities of features, labeling transactions of a second bin of the plurality of bins and a second-to-last bin of the plurality of bins as either fraudulent or legitimate; and
storing the labeled transactions of the first bin, second bin, second-to-last bin, and last-bin in the transaction repository.

2. The system of claim 1, wherein the operations further comprise:
with the transaction classification model and the labeled transactions of the first bin, second bin, second-to-last bin, and last-bin and their respective pluralities of respective features, training a second machine learning model;
with the trained second machine learning model, labeling transactions of a third bin and a third-to-last bin of the plurality of bins as either fraudulent or legitimate; and
storing the labeled transactions of the third bin and the third-to-last bin in the transaction repository.

3. The system of claim 2, wherein the operations further comprise:
with the transaction classification model and the labeled transactions of the first bin, second bin, nth bin, nth-to-last bin, second-to-last bin, and last-bin and their respective pluralities of respective features, training an nth machine learning model.

4. The system of claim 3, wherein the operations further comprise:
receiving a second plurality of transactions; and
with the trained nth machine learning model, classifying transactions of the second plurality of transactions as either fraudulent or legitimate.

5. The system of claim 4, wherein the operations further comprise:
blocking the transactions of the second plurality of transactions that are classified as fraudulent.

6. The system of claim 4, wherein the operations further comprise:
for each transaction of the second plurality of transactions that is classified as fraudulent, generating an alert message to a user.

7. The system of claim 4, wherein the operations further comprise:
for each transaction of the second plurality of transactions that is classified as fraudulent, passing the transaction to a fraud investigator processor via a network.

8. The system of claim 4, wherein the first machine learning model or the second machine learning model comprises an adaptive entropy gradient model.

9. The system of claim 1, wherein the bins of the plurality of bins are of equal risk score width.

10. The system of claim 1, wherein determining the respective plurality of transaction risk scores comprises:
segmenting the plurality of unlabeled transactions into segments; and
running the anomaly detection model on each segment separately.

11. A computer-implemented method for automatically identifying suspected fraudulent transactions, the method comprising:
with a fraud management server having at least one processor and a non-transitory computer readable medium operably coupled thereto, the server being in electronic communication with a computing device of a financial institution, the processor comprising a transaction repository, an anomaly detection model, and a transaction classification model, the server being in electronic communication with a database for storing a plurality of features for a plurality of transactions associated with the financial institution:
receiving a plurality of unlabeled transactions, each transaction having a respective plurality of features;
storing the unlabeled transactions in the transaction repository;
with the anomaly detection model and the respective pluralities of features for the plurality of unlabeled transactions, determining a respective plurality of transaction risk scores, wherein each transaction risk score is a value between 0 and 1, wherein higher values represent a greater risk that the transaction is fraudulent;
based on the plurality of transaction risk scores, dividing the unlabeled transactions into a plurality of bins, wherein a first bin of the plurality of bins contains transactions with the lowest respective risk scores, and wherein a last bin of the plurality of bins contains transactions with the highest respective risk scores;
labeling transactions of the first bin of the plurality of bins as legitimate;
labeling transactions of the last bin of the plurality of bins as fraudulent;
with the transaction classification model and the labeled transactions of the first and last bins and their respective pluralities of respective features, training a first machine learning model;
with the trained first machine learning model and the respective pluralities of features, labeling transactions of a second bin of the plurality of bins and a second-to-last bin of the plurality of bins as either fraudulent or legitimate; and
storing the labeled transactions of the first bin, second bin, second-to-last bin, and last-bin in the transaction repository.

12. The method of claim 11, further comprising:
with the transaction classification model and the labeled transactions of the first bin, second bin, second-to-last bin, and last-bin and their respective pluralities of respective features, training a second machine learning model;
with the trained second machine learning model, labeling transactions of a third bin and a third-to-last bin of the plurality of bins as either fraudulent or legitimate; and
storing the labeled transactions of the third bin and the third-to-last bin in the transaction repository.

13. The method of claim 12, further comprising:
with the transaction classification model and the labeled transactions of the first bin, second bin, nth bin, nth-to-last bin, second-to-last bin, and last-bin and their respective pluralities of respective features, training an nth machine learning model.

14. The method of claim 13, further comprising:
receiving a second plurality of transactions; and
with the trained nth machine learning model, classifying transactions of the second plurality of transactions as either fraudulent or legitimate.

15. The method of claim 14, further comprising:
blocking the transactions of the second plurality of transactions that are classified as fraudulent.

16. The method of claim 14, further comprising:
for each transaction of the second plurality of transactions that is classified as fraudulent, generating an alert message to a user.

17. The method of claim 14, further comprising:
for each transaction of the second plurality of transactions that is classified as fraudulent, passing the transaction to a fraud investigator processor via a network.

18. The method of claim 14, wherein the first machine learning model or the second machine learning model comprises an adaptive entropy gradient model.

19. The method of claim 11, wherein the bins of the plurality of bins are of equal risk score width.

20. The method of claim 11, wherein determining the respective plurality of transaction risk scores comprises:
segmenting the plurality of unlabeled transactions into segments; and
running the anomaly detection model on each segment separately.
